(19) United States
(12) Patent Application Publication
(10) Pub. No.: US 2025/0051162 A1
(43) Pub. Date: Feb. 13, 2025

(54) SYSTEMS AND METHODS FOR USING HEAT PRODUCED FROM ACID GENERATION

(71) Applicant: Sublime Systems, Inc., Somerville, MA (US)

(72) Inventors: Jesse D. BENCK, Wakefield, MA (US); Yet-Ming CHIANG, Wellesley, MA (US); Michael CORBETT, Medford, MA (US); Kyle DOMINGUEZ, Boston, MA (US); Leah D. ELLIS, Somerville, MA (US); Khashayar JAFARI, Melrose, MA (US); Mariya LAYUROVA, Cambridge, MA (US)

(73) Assignee: Sublime Systems, Inc., Somerville, MA (US)

(21) Appl. No.: 18/717,854

(22) PCT Filed: Dec. 8, 2022
(86) PCT No.: PCT/US2022/081160

§ 371 Date: Jun. 7, 2024

Related U.S. Application Data
(60) Provisional application No. 63/287,293, filed on Dec. 8, 2021.

(51) Int. Cl. C01B 7/01; C01B 7/09; C01B 7/19; C01F 11/02

(52) U.S. Cl. CPC C01B 7/012; C01B 7/093; C01B 7/191; C01F 11/02

(57) ABSTRACT

Provided herein are methods and systems for using heat from acid generation, comprising: an acid generating system configured to generate heat and an acid: a wet solids generating system configured to: dissolve a first calcium source in the acid; and precipitate a second calcium source using the dissolved first calcium source to generate a wet solid; and a dryer configured to dry the wet solid using the heat from the acid generating system.

### CROSS-REFERENCE TO RELATED APPLICATION

This application claims the benefit of U.S. Provisional Application No. 63/287,293 filed Dec. 8, 2021, the entire contents of which are incorporated herein by reference.

### FIELD

This disclosure relates generally to using heat produced from acid generation, and more specifically to using heat produced from acid generation in a cement making process.

### BACKGROUND

In the construction industry, there are many chemical processes and material synthesis operations that are energy-intensive and require large amounts of heat for operation. These thermal processes traditionally rely on fossil fuel combustion to generate heat, which greatly contributes to greenhouse gas (e.g., CO₂) emissions in the environment. For example, in cement production, converting limestone and clay into cement clinker using a rotary kiln requires burning fossil fuels at temperatures up to 1500° C.

### SUMMARY

As described above, energy-intensive thermal processes, such as those experienced in making cement, burn fossil fuels to generate the large amounts of heat used to produce cement. Fossil fuels emit significant quantities of greenhouse gases, such as carbon dioxide (CO₂), into the atmosphere.

The systems and methods disclosed herein provide a cement making process that includes using heat produced and subsequently captured in cement production for other aspects of the cement making process. For example, heat produced by chemical processing equipment (e.g., acid burners and/or acid absorbers) executing largely exothermic reactions can be captured and used for other subprocesses of a cement production, such as for drying wet solid products. In applying the heat produced in cement production to other subprocesses, the systems and methods described herein may improve upon conventional cement making processes because fossil fuel combustion is not needed, which in turn minimizes CO₂ emissions in the environment. Moreover, the electrochemical cement making systems and methods described herein may not rely on fossil fuel combustion to generate heat for driving reactions, thus further minimizing CO₂ emissions. The disclosed systems and methods may provide higher reaction temperature heat, which may lead to faster processing times. An additional advantage may include a simplified material supply chain and reduced costs associated with making cement, at least because heat generated internally in the cement making process is captured and used for other subprocesses, and thus conventionally used external heat sources (e.g., fossil fuel combustion) may not be necessary.

In some embodiments, a system for using heat from acid generation is provided comprising: an acid generating system configured to generate heat and an acid; a wet solids generating system configured to: dissolve a first calcium source in the acid; and precipitate a second calcium source using the dissolved first calcium source to generate a wet solid; and a dryer configured to dry the wet solid using the heat from the acid generating system.

In some embodiments, the acid generating system comprises a heat exchanger configured to transfer the heat from the acid generating system to a heat transfer fluid.

In some embodiments, the dryer is configured to dry the wet solid using heat from the heat transfer fluid.

In some embodiments, the system comprises a second heat exchanger configured to transfer heat from the first heat transfer fluid to a second heat transfer fluid.

In some embodiments, the dryer is configured to dry the wet solid using heat from the second heat transfer fluid.

In some embodiments, the system comprises: a sensor configured to measure a property of the dried wet solid; and a controller configured to adjust the flow of the second heat transfer fluid to the dryer based on a determination that the measured property of the dried wet solid is outside of a threshold range.

In some embodiments, the sensor is a moisture sensor, and the property is moisture content.

In some embodiments, the threshold range is a moisture content of 0.1-10 wt. %.

In some embodiments, the system comprises: a sensor configured to measure a property of the second heat transfer fluid after the second heat exchanger; and a controller configured to adjust the flow of the first heat transfer fluid to the second heat exchanger based on a determination that the measured property of the second heat transfer fluid is outside of a threshold range.

In some embodiments, the sensor is a temperature sensor, and the property is temperature.

In some embodiments, the system comprises: a sensor configured to measure a property of the dried wet solid source; and a controller configured to adjust the flow of the heat transfer fluid based on a determination that the measured property of the dried wet solid is outside of a threshold range.

In some embodiments, the acid generating system is configured to generate heat and an acid using a hydrogen gas and a halide gas.

In some embodiments, the acid generating system comprises a burner configured to generate a hydrogen halide gas using the hydrogen gas and the halide gas; and an absorber configured to absorb the hydrogen halide gas in a solvent to form the acid.

In some embodiments, the halide gas comprises a dihalide gas.

In some embodiments, the dihalide gas comprises F₂, Cl₂, or Br₂.

In some embodiments, the hydrogen halide gas comprises hydrogen chloride.

In some embodiments, the wet solid generating system comprises a dissolution chamber configured to dissolve the first calcium source in the acid; and a precipitation chamber configured to precipitate the second calcium source using the dissolved first calcium source.

In some embodiments, the first calcium source comprises calcium carbonate, lime, lime dust, lime kiln dust, cement kiln dust, slag from metal production, igneous or metamorphic rock, and/or furnace ash.

In some embodiments, the second calcium source comprises calcium hydroxide.

In some embodiments, the first calcium source comprises a pozzolan source.

In some embodiments, dissolving the first calcium source comprising the pozzolan source comprises generating a second wet solid comprising the pozzolan source.

In some embodiments, the dryer is configured to dry the second wet solid comprising the pozzolan source.

In some embodiments, a method for using heat in acid generation is provided, comprising: generating heat and an acid; dissolving a first calcium source in the acid; precipitating a second calcium source using the dissolved first calcium source to generate a wet solid; and drying the wet solid using the heat from the acid generation.

In some embodiments, the method comprises transferring the heat generated to a heat transfer fluid and drying the wet solid using the heat transfer fluid.

In some embodiments, the method comprises transferring heat from the heat transfer fluid to a second heat transfer fluid and drying the wet solid using the second heat transfer fluid.

In some embodiments, a method for using heat in acid generation is provided, comprising: generating heat and an acid; dissolving a first calcium source in the acid; precipitating a second calcium source using the dissolved first calcium source; and performing an operation using the heat from acid generation.

In some embodiments, the operation comprises evaporating a solvent.

In some embodiments, the operation comprises drying a wet solid or drying an input source such as coal ash or mining tailings.

In some embodiments, systems and methods are provided comprising using heat released during hydrogen halide formation reactions for chemical processing or material synthesis operations that require heat input.

In some embodiments, said heat is released as the enthalpy of reaction of molecular hydrogen (H₂) with a dihalide (X₂, where X═F, Cl, or Br) to create a hydrogen halide (HX). In some embodiments, the hydrogen halide is hydrogen chloride.

In some embodiments, the chemical processing or material synthesis comprises drying, calcining, or reacting materials.

In some embodiments, the materials comprise limestone, calcium hydroxide, clays, and/or cement materials.

In some embodiments, the chemical processing or material synthesis comprises calcination of limestone to make quicklime, calcination of clay for pozzolan production, drying lime slurry to make dry lime, calcination of calcium hydroxide for cement production, reaction of lime with silica to form alite, and/or reaction of limestone, clay, and sand to form Portland cement clinker.

Additional advantages will be readily apparent to those skilled in the art from the following detailed description. The examples and descriptions herein are to be regarded as illustrative in nature and not restrictive.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

### BRIEF DESCRIPTION OF FIGURES

The invention will now be described, by way of example only, with reference to the accompanying drawings, in which:

FIG. 1A shows a first block diagram for using heat produced in acid generation, in accordance with some embodiments.

FIG. 1B shows a second block diagram for using heat produced in acid generation, in accordance with some embodiments.

FIG. 1C shows a third block diagram for using heat produced in acid generation, in accordance with some embodiments.

FIG. 2 shows a process diagram for using heat produced from acid generation to dry a wet solid, in accordance with some embodiments.

FIG. 3 shows a phase diagram for the reaction of lime and silica, in accordance with some embodiments.

Like reference numbers in the Figures refer to like components/steps unless otherwise stated herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Described herein are systems and methods for using heat released during a cement making process in other subprocesses of the cement making process. In some embodiments, the cement production system described herein may utilize an acid generating system to produce an acid, such as a hydrogen halide, for dissolving a calcium and/or silica source. The heat generated in synthesizing the acid may be captured and used in other subprocesses of cement production. For example, the heat may be used to thermally treat products (e.g., wet solids) outputted by a wet solids generating system (e.g., comprising a dissolution chamber and/or precipitation chamber) of a cement making system to produce a dried, dehydrated, and/or sintered calcium and/or silica product. For example, the calcium source may be hydrated lime, and the silica source may comprise pozzolan, each of which may be integrated downstream individually and/or in combination as components of a cement product.

By using an electrochemical process to produce the hydrated lime and/or pozzolan components of cement rather than relying on fossil fuel combustion to provide the heat necessary for the various reactions, greenhouse gas (e.g., CO₂) emissions can be minimized. In addition, by capturing the heat generated from the acid generating system during cement production and using the heat in other subprocesses of the cement production, the amount of CO₂ emitted in the environment may be further minimized. In the instance the acid generating system is powered by renewable energy sources, the thermally treated materials described herein may be carbon neutral.

The below disclosure first introduces the chemistry related to example acid generation reactions (e.g., hydrogen halide synthesis reactions), which may be utilized in the cement making process described herein. Then, the heat requirement for chemical processing and material synthesis reactions and how this affects energy-intensive thermal processes in the construction industry is described. Following the description of the related chemistry, an electrochemical system for making cement product components is provided, with an emphasis on the acid generation system which produces heat that can be captured and used as input in other subsystems of a cement making process. Finally, various potential uses for heat captured from acid generation are described.

### Hydrogen Halide Synthesis

Molecular hydrogen (H₂) may react with dihalides (e.g., fluorine (F₂), chlorine (Cl₂), bromine (Br₂), etc.) to create hydrogen halides (e.g., HF, HCl, HBr, etc.). These reactions may occur at high temperatures and release large amounts of heat due to strongly exothermic reaction enthalpies. Reaction Equations and standard enthalpies of formation for each hydrogen halide are shown below in Equations 1, 2, and 3, where negative values correspond to exothermic reactions:

$$\begin{matrix}\frac{1}{2} {H}_{2} \to \frac{1}{2} {F}_{2} \to HF & Δ H = - 273.3 kJ / mol & Eq . 1 \\ \frac{1}{2} {H}_{2} \to \frac{1}{2} {Cl}_{2} \to HCl & Δ H = - 92.3 kJ / mol & Eq . 2 \\ \frac{1}{2} {H}_{2} \to \frac{1}{2} {Br}_{2} \to HBr & Δ H = - 36.3 kJ / mol & Eq . 3\end{matrix}$$

These reactions may take place using a variety of reaction pathways, in a variety of chemical processes, and using various types of chemical process equipment. The reaction of molecular hydrogen (H₂) and molecular chlorine (Cl₂) to form hydrogen chloride (HCl) occurs in the synthesis of hydrochloric acid solutions, which may be carried out using a chlor-alkali process. Chlor-alkali reactors (e.g., electrolyzers) may accept inputs comprising NaCl, H₂O, and electricity, and produce outputs comprising Cl₂, H₂, and NaOH. These chlor-alkali reactors can also accept other inputs to produce other outputs depending on the desired reaction of the reactors.

In a chlor-alkali reactor, molecular chlorine (Cl₂) may be produced through oxidation of Cl— ions at an anode, shown below in Equation 4, and molecular hydrogen (H₂) may be produced through reduction of water at a cathode, shown below in Equation 5. Molecular chlorine may be reacted with molecular hydrogen to form hydrogen chloride (as shown above in Eq. 2). Hydrogen chloride gas may be dissolved in water to make a hydrochloric acid solution.

$$\begin{matrix}2 Cl - \to {Cl}_{2} + 2 e - & Eq . 4 \\ 2 {H}_{2} O + 2 e - \to {H}_{2} + 2 OH - & Eq . 5\end{matrix}$$

The hydrogen chloride synthesis reaction may release a large quantity of heat due to the strongly exothermic enthalpy of reaction. In some embodiments, given the heat capacity of the HCl product, the 92.3 KJ/mol heat released through the reaction may increase the temperature of the HCl vapor by up to 2900° C. Chemical process equipment such as acid burners designed for HCl synthesis may operate at temperatures above 2000° C., 2100° C., 2200° C., 2300° C., 2400° C., or 2500° C.

### Chemical Processing and Material Synthesis

Many chemical or structural changes within materials systems may require heat to be provided at a certain temperature for a variety of reasons, including but not limited to driving reactions to high conversion, increasing the kinetics of a reaction, stabilizing desired material phases, evaporating solvents such as water, evolving chemically bound gaseous species, drying wet solid products, and more. In general, physical systems are believed to move towards chemical equilibrium, defined as the system configuration which may have the lowest Gibbs free energy, or G, as defined by Equation 6 provided below, where His system enthalpy, Tis system temperature, and S is system entropy. Following this principle, a chemical reaction is believed to occur when the ΔG of the reaction is less than zero, that is, the reaction occurring will serve to lower the system's Gibbs free energy. Given the definitions of chemical equilibrium, both temperature and pressure are constant, leading to only considerations in enthalpy and entropy to drive ΔG, as seen below in Equation 7.

$$G = H - TS \qquad Eq . 6$$

$$Δ G = Δ H - T Δ S \qquad Eq . 7$$

In the case of an endothermic reaction, which may occur when driving off gaseous species or evaporating solvents, by definition the ΔH is positive. Therefore, the only way to have ΔG<0, and drive the reaction forward, is to adjust temperature such that the product of temperature and entropy (TAS) is greater than the change in enthalpy (i.e., TΔS>ΔH). Depending on the specific values of ΔS and ΔH for a reaction, the temperature T may vary. The stability of reaction phases may also depend on the composition and temperature of the system. The temperature-composition space can be represented by adding new enthalpies and entropies, ΔHₘᵢₓ and ΔSₘᵢₓ to the system. The concept of minimizing free energy still applies, with the added complexity that a mixture of phases may be more stable than a single phase below a certain temperature. These intricacies are captured in phase diagrams, which may be used to explore the temperature-composition space for various processing strategies.

While satisfying this ΔG<0 requirement for a reaction to proceed is a given requirement, there may be other inhibitions preventing a reaction from driving forward. If the reactants from a given reaction cannot reach each other, the reaction will not proceed. For example, using the hypothetical solid-state reaction in Equation 8 provided below, if reactant A cannot diffuse sufficiently to reach reactant B, product AB will never be generated. Diffusion tends to be governed by an Arrhenius relation, depicted in Equation 9 below. An activation energy for diffusion must be overcome before the reaction may proceed with a reasonable rate. Because of the negative exponential with temperature in the denominator, increasing diffusion D for a fixed system may only happen by increasing the temperature. Therefore, certain solid-state reactions may require a temperature higher than the temperature T for ΔG<0 for them to proceed in a reasonable amount of time.

$$A + B \to AB \qquad Eq . 8$$

$$D = {D}_{o} exp [ - {E}_{a} / {k}_{B} T ] \qquad Eq . 9$$

An example system in the construction industry that exhibits many of these temperature requirements is the production of low carbon steel. At room temperature, the ΔG<0 phase stability is carbon and iron (C+Fe). However, at higher temperatures, it's austenite. To form austenite, the temperature may be increased to 900° C. for ΔG<0 for phase stability, but then it can be quenched. During quenching, despite the fact that ΔG<0 wants to form C+Fe, the carbon is locked into its structure because of the solid diffusion, preventing the decomposition.

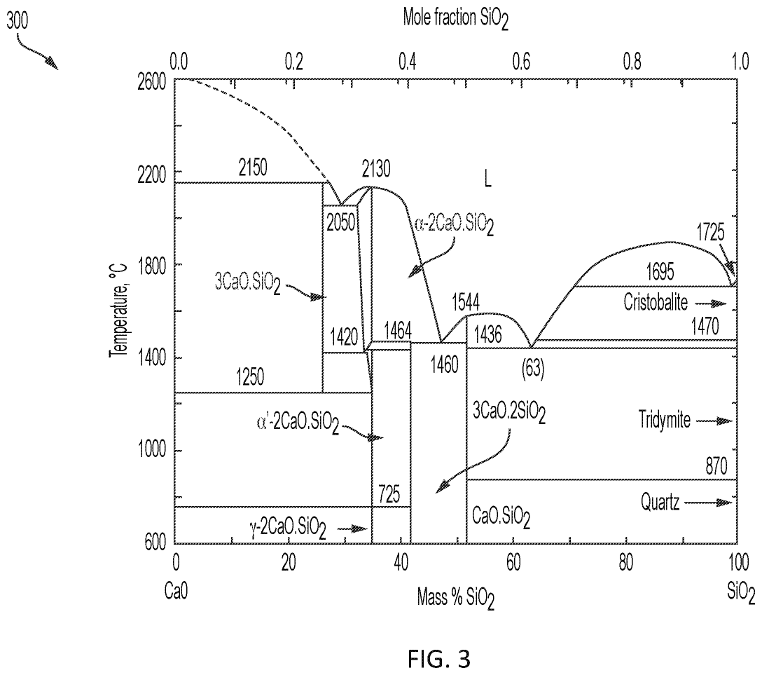

Another example of an energy-intensive thermal process in the construction industry is cement production. Specifically, converting limestone and clay into cement clinker using a rotary kiln requires burning fossil fuels with temperatures up to 1500° C. This process involves two steps, both thermally activated. The first step involved calcining limestone (CaCO₃) to lime (CaO) by driving off the CO₂ in an endothermic process that occurs at around 900° C. The second step involves heating the CaO with clay to form the major cement clinker phases, such as Alite (Ca₃SiO₅), Belite (Ca₂SiO₄), Aluminate (Ca₃Al₂O₆) and Ferrite (Ca₄Al₂Fe₂O₁₀). This second step is a thermally induced phase transformation. In producing cement, the ratios between CaO, SiO₂, Al₂O₃, and Fe₂O₃ are dependent on specific requirements for a given cement blend. Generally, the preferred phase to form is Alite as it has fast reactivity at early ages. The formation of Alite requires high temperatures since it is a line compound. For example, the phase diagram shown in FIG. 3 provides formation temperatures for various phases produced in reacting (CaO) and silica (SiO₂). As shown, Alite (otherwise notated 3CaO·SiO₂ in FIG. 3) may have a formation temperature of 1250° C. However, due to both heat gradients and diffusivity limitations, the kiln temperature target is 1500° C. This temperature may match the minimum temperature for sintering, which is a process limited by solid-state diffusion. Sintering in ceramic materials is considered to be activated at 0.67 Tₘ, where Tₘ is the melting temperature of the material or phase to create. Because the melting point of the Alite (Ca₃SiO₅) phase is 2150° C. (shown in FIG. 3), the minimum temperature for good solid transport is about 1440° C.

Based on the large amounts of fossil fuels used processing and the chemical emissions of the CO₂ from the limestone, it is estimated that to roughly one kilogram of CO₂ emissions per kilogram of cement is released into the atmosphere. Thus, the methods and systems described herein aim to perform such energy-intensive thermal processing without the use of or minimal use of fossil fuels, thereby minimizing CO₂ emissions.

### Systems for Using Heat Produced in Acid Generation

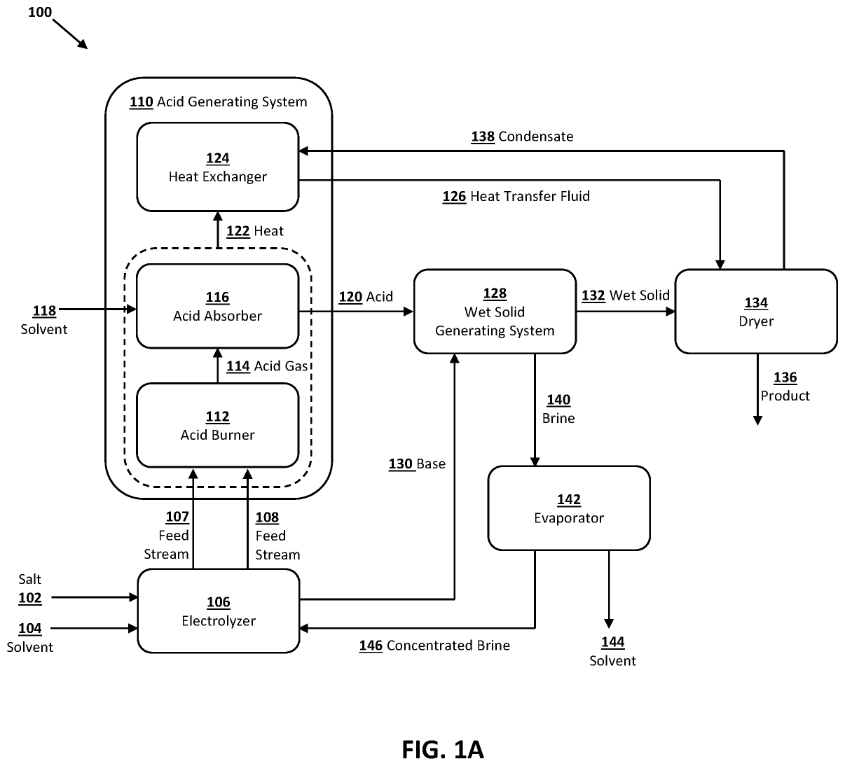

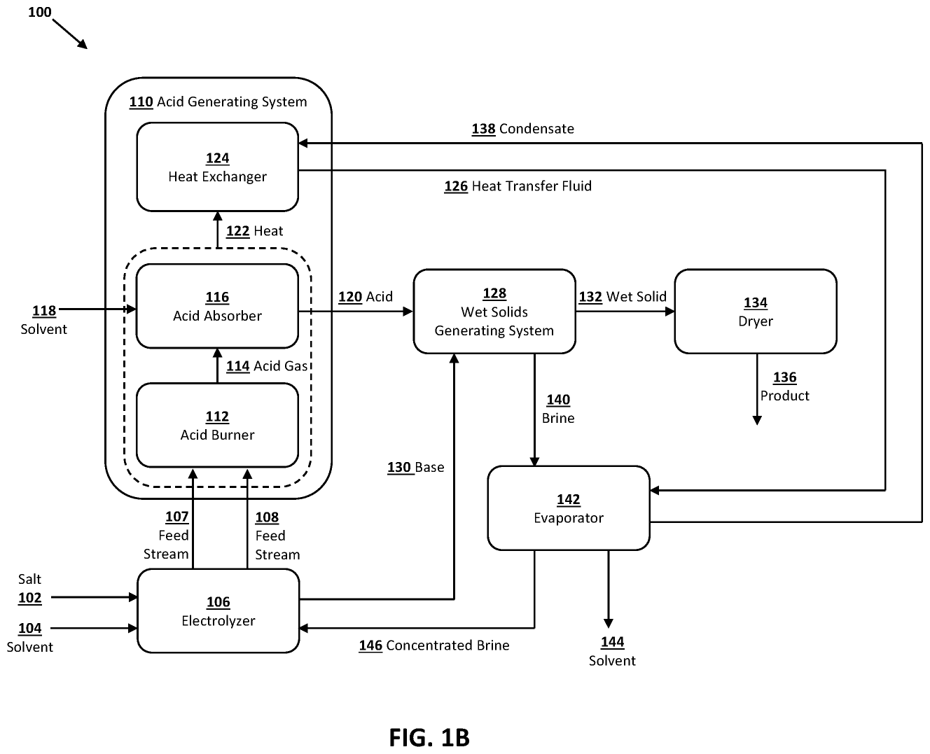

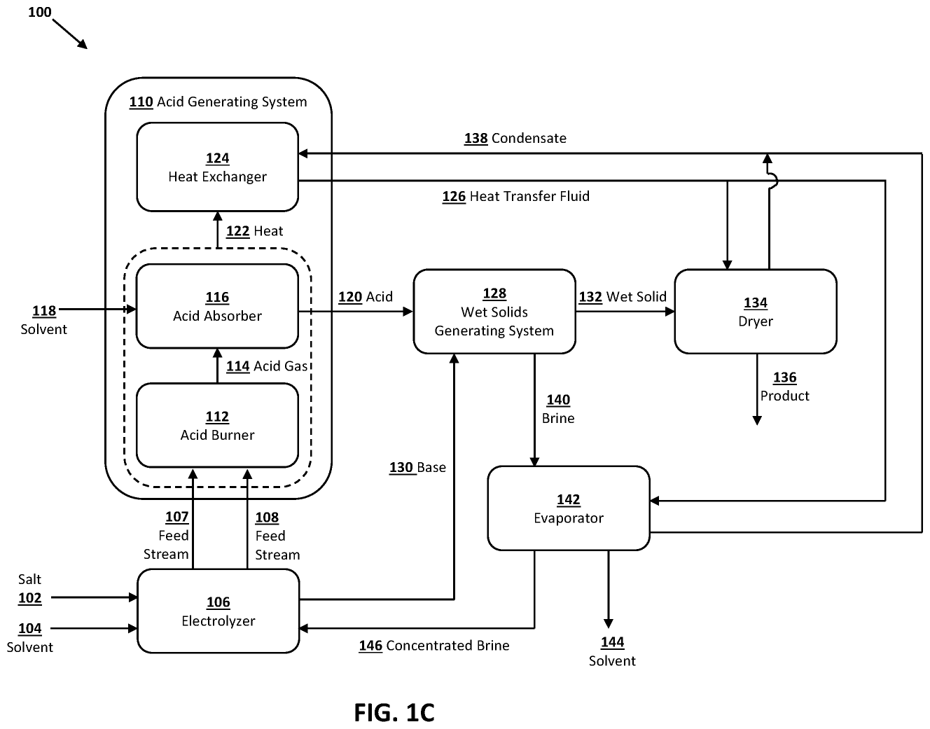

FIG. 1A illustrates a block diagram of a system 100 that uses heat produced from acid generation to dry wet solid products, in accordance with some embodiments. System 100 may produce dried, dehydrated, and/or sintered calcium hydroxide (e.g., hydrated lime, or Ca(OH)₂), pozzolan (which comprises silica, or SiO₂), and/or other cement components which may be integrated into a cement blend.

Acid generation may begin with obtaining the necessary reactants to produce an acid. For example, in some embodiments, salt 102 and solvent 104 may be inputted to an electrolyzer 106. In some embodiments, the salt may comprise chlorine (Cl) (e.g., sodium chloride (NaCl), potassium chloride (KCl), etc.), bromine (Br) (e.g., sodium bromide (NaBr), potassium bromide (KBr), etc.), fluorine (F) (e.g., sodium fluoride (NaF), potassium fluoride (KF), etc.), or combinations thereof. In some embodiments, solvent 104 may comprise water, deionized water, recycled brine, other solvents, or combinations thereof. In some embodiments, the electrolyzer 106 may be configured to produce first feed stream 107 and second stream feed 108 using electricity. In some embodiments, the electrolyzer 106 may be a chlor-alkali reactor. With an input of sodium chloride and water, the chlor-alkali reactor may produce chlorine (Cl₂) through oxidation of Cl-ions at an anode of the chlor-alkali reactor, and hydrogen (H₂) through reduction of water at a cathode of the chlor-alkali reactor. As shown in Equation 10 provided below, the reaction may additionally produce a basic (e.g., sodium hydroxide (NaOH)) solution that may be provided to a wet solid generating system, as will be described in greater detail below. Using any combination of the above-mentioned salts and/or solvents, various products (e.g., feed streams 107, 108, and/or base 130) may be generated using electrolyzer 106, including but not limited to acid precursor solutions (e.g., halide gases, hydrogen gas, etc.), basic solutions, etc., or combinations thereof. The solutions may be gases, liquids, and/or a combination thereof. For example, a halide gas may comprise a dihalide gas such as H₂, Cl₂, Br₂, F₂, etc., or combinations thereof. A basic solution may comprise NaOH, KOH, etc.

$$NaCl + {H}_{2} O \to NaOH + 1 / 2 {H}_{2} + 1 / 2 {Cl}_{2} \qquad Eq . 10$$

In some embodiments, feed streams 107 and 108 may be provided from electrolyzer 106 to one or more modules of an acid generating system 110. For example, electrolyzer 106 may be fluidically connected to one or more modules of acid generating system 110. In some embodiments, instead or in addition to receiving reactants for acid generation from electrolyzer 106, first feed stream 107 and/or second feed stream 108 may be provided from a different source. For example, the feed stream(s) of the acid generating system may be from feed source(s) or reservoir(s). The feed source and/or reservoir may comprise acid gas precursors including but not limited to nitrogen (N₂), ammonia (NH₃), sulfur(S), sulfur dioxide (SO₂), hydrogen (H₂), chlorine (Cl₂), bromine (Br₂), fluorine (F₂), etc., or combinations thereof.

Acid generating system 110 may comprise one or more modules (e.g., chambers, units, reactors etc.) configured to generate heat and an acid via an acid synthesis reaction. For example, acid generating system 110 may comprise an acid burner 112 and/or an acid absorber 116. In some embodiments, the feed source(s) (e.g., electrolyzer 106) may be fluidically connected to acid burner 112 of the acid generating system, such that the feed source (e.g., electrolyzer 106) may provide first feed stream 107 and second feed stream 108 as inputs to acid burner 112 to generate acid gas 114. In some embodiments, acid burner 112 may be configured to generate a hydrogen halide gas from the first feed stream 107 (e.g., a hydrogen gas) and second feed stream 108 (e.g., halide gas). As mentioned above, the halide gas may comprise a dihalide gas, such as F₂, Cl₂, Br₂, or combinations thereof. The acid gas 114 generated by acid generating system 110 (e.g., acid burner 112) may comprise a hydrogen halide gas, such as hydrochloric acid, hydrobromic acid, hydrofluoric acid, or combinations thereof. In some embodiments, acid gas 114 may instead or additionally include sulfuric acid, sulfurous acid, nitric acid, or combinations thereof.

In some embodiments, acid generating system 110 (e.g., acid burner 112) may conduct a combustion reaction to generate acid gas 114. In a combustion reaction, an oxidant (e.g., O₂, Cl₂, F₂, Br₂, etc.) may be reacted with a fuel (e.g., H₂, NH₃, N₂, S, SO₂, etc.) to generate a gas (e.g., anhydrous gas) of an acid, including but not limited to HCl, HF, HBr, NO, HNO₃, H₂SO₃, H₂SO₄, NO₂, SO₂, SO₃, etc., or combinations thereof.

In some examples, first and second feed streams 107, 108 may comprise chlorine (Cl₂) and hydrogen (H₂). Acid burner 112 may be used to react H₂ and Cl₂ to produce hydrochloric acid (HCl) gas, shown below in Equation 11. As mentioned above, the reaction of H₂ and Cl₂ is a largely exothermic process that releases a large amount of heat. For example, the amount of heat released through the reaction may increase the temperature of the acid gas 114 by up to 2900° C. In some embodiments, acid burner 112 has a temperature of greater than or equal to 2000° C., 2100° C., 2200° C., 2300° C., 2400° C., or 2500° C. to synthesize acid gas 114. In some embodiments, acid burner 112 has a temperature of less than or equal to 2000° C., 2100° C., 2200° C., 2300° C., 2400° C., or 2500° C. to synthesize acid gas 114.

$$1 / 2 {H}_{2} + 1 / 2 {Cl}_{2} \to HCl \qquad Eq . 11$$

As mentioned above, the acid generating system 110 may additionally comprise an acid absorber 116 configured to absorb the acid gas produced by acid burner 112 in a solvent to form acid 120. In some embodiments, acid absorber 116 may be fluidically connected to acid burner 112, such that the product of acid burner 112 (e.g., acid gas 114) may be provided as input to acid absorber 116. In some embodiments, in addition to or instead of receiving an acid gas from acid burner 112, acid absorber 116 may be configured to receive one or more of the aforementioned acid gases from a feed source and/or reservoir. Using acid absorber 116 and an input solvent (e.g., water) source 118, the acid gas 114 may be dissolved in solvent 118 to produce an acid 120. In some embodiments, acid 120 may comprise a solution comprising one or more of the above-mentioned acid gases (e.g., hydrochloric acid, hydrobromic acid, hydrofluoric acid, sulfuric acid, sulfurous acid, nitric acid, etc.).

In some embodiments, acid generating system 110 (e.g., acid absorber 116) may conduct a heat of dilution reaction to produce acid 120. For example, a gas (e.g., produced in a combustion reaction) may be absorbed in a solvent (e.g., water) to form the corresponding high concentration acid. The heat of dilution reaction may be exothermic, thus releasing quantities of heat that may be captured in acid generating system 110 for later use (as described in greater detail below).

In some embodiments, an acid (e.g., an acidic solution) may be provided as input to acid generating system 110. For example, in addition to or instead of generating acid 120 using an acid absorber 116 of acid generating system 110, an acid stream comprising one or more of the aforementioned acids may be provided to acid generating system 110. The acid may be a high concentration acid that may be diluted to a lower concentration (e.g., using acid absorber 116). In some embodiments, the heat released in diluting the high concentration acid to a lower concentration may be captured.

In some embodiments, acid generating system 110 (e.g., comprising acid burner 112 and/or acid absorber 116) may be a cylindrical (e.g., tubular) or spherical vessel comprising graphite, a ceramic material, a metal such as stainless steel, and/or other materials. For example, acid burner 112 may be a tubular reactor, wherein the first feed stream 107 and second feed stream 108 are flowed into the tubular reactor, and the acid generation reaction occurs inside the reactor. The acid burner 112 and acid absorber 116 of acid generating system 110 may comprise any known acid burner system, including but not limited to a top burner design and a bottom burner design. In some embodiments, acid generating system 110 may comprise a known hydrochloric acid synthesis reactor, such as an SGL Carbon synthesis system, Mersen SINTACLOR® unit (e.g., SINTACLOR® I, SINTACLOR® II, and/or SINTACLOR® III), etc.

In some embodiments, as illustrated in FIG. 1A, the heat 122 produced in one or more modules of acid generating system 110 (e.g., acid burner 112 and/or acid absorber 116) may be captured within acid generating system 110 using a heat exchanger 124. Heat exchanger 124 may be configured to transfer heat 122 from acid generating system 110 to a heat transfer fluid 126, described in greater detail below. The heat captured by heat transfer fluid 126 may be provided to a subsystem of system 100 to perform one or more operations using the heat from acid generation in system 100. For example, the operation may comprise drying a wet solid(s), evaporating solvent(s) (e.g., water), and/or drying an input source such as coal ash or mining tailings, for example.

In some embodiments, heat 122 generated from one or more modules of acid generating system 110 (e.g., acid burner 112 and/or acid absorber 116) may be conveyed directly to another subsystem of system 100 (e.g., dryer 134, described below) without the use of heat transfer fluid 126. In some embodiments, a hot acid (e.g., hydrogen halide) stream may be flowed through a kiln or other reactor that contains materials to be heated or reacted. For example, a hot stream of acid gas 114 may be directed to flow through the inside of a cement kiln, thus transferring heat directly to the solid materials inside.

In some embodiments, heat 122 generated from modules of acid generating system 110 may be transferred to other materials by conduction and/or radiation through a solid material (e.g., heat exchanger), such as the wall of a reaction vessel. For example, acid burner 112 may be tubular and enclose a smaller internal vessel, or, in another example, acid burner 112 may be surrounded by a larger external vessel, such as a larger coaxial cylindrical vessel (e.g., acid generating system 110). In some embodiments, the second vessel may contain a solid, liquid, and/or gaseous material (e.g., heat transfer fluid) that may be heated and used to drive a chemical process (e.g., calcination, drying, etc.). In some embodiments, acid burner 112 may be disposed inside or outside of a kiln. For example, the kiln may be used to calcine limestone to create calcium oxide, heat limestone, clay, and/or sand to make cement (e.g., Portland cement), etc. In some embodiments, acid burner 112 may be disposed inside or outside a dryer (e.g., dryer 134) used to dry wet lime, limestone, silica, and/or other materials via the evaporation of water and/or other solvents. In some embodiments, heat 122 from acid burner 112 may be transferred to a limestone, clay, sand, and/or other lime material by conduction, convection, and/or radiation from the surface of acid burner 112 directly to the material and/or mixture to be heated, without the use of a heat transfer fluid (e.g., heat transfer fluid 126).

As mentioned above, heat transfer equipment such as heat exchanger 124 may transfer and utilize heat 122 released in the acid generating system 110 (e.g., from acid burner 112 and/or acid absorber 116). Heat exchanger 124 may be a jacketed reactor vessel, internal coil, shell and tube, double pipe, plate and frame design, other heat exchangers, or combinations thereof. In some embodiments, the heat 122 produced in acid generating system 110 may be conducted through the reactor wall material (e.g., through the wall of the acid burner 112 and/or acid absorber 116) and transferred to a heat transfer fluid 126 (e.g., in the liquid or gas phase) via conduction, convection, and/or radiation. In some embodiments, heat transfer fluid 126 may be flowed around, through, and/or inside a reactor. For example, heat transfer fluid 126 may be water, and the water may be flowed around the outside of acid burner 112 and/or acid absorber 116 through a vessel jacket to absorb the heat produced by the reactor(s). In some embodiments, heat transfer fluid 126 may comprise water, air, alcohol, pentane, toluene, fluorocarbons, molten salt, a mixture of compounds, and/or other heat transfer fluids. In some embodiments, the heat transfer fluid 126 may comprise condensate 138 produced from using heat transfer fluid 126 at one or more subsystems of system 100. For example, the heat from the acid generating system can be used to create steam. When the heat from the steam is used in one or more subsystems of system 100, the steam can condense to water, which can be sent back to the acid generating system or heat exchanger of the acid generating system to create more steam. In some embodiments, heat exchanger 124 (or another chemical process vessel) may produce heat transfer fluid 126 and heat transfer fluid 126 may be used to heat another subsystem and/or process stream of system 100.

In some embodiments, the energy efficiency of the heat transfer process may be limited by the efficiency of heat exchanger 124. In some embodiments, a cold reservoir of heat transfer fluid 126 is used. For example, the cold reservoir may consist of liquid water at ambient temperature (e.g., about 22° C.). In some embodiments, the liquid water may comprise a temperature less than or equal to 20° C., 22° C., 25° C., 30° C., 35° C., or 40° C. In some embodiments, the liquid water may comprise a temperature greater than or equal to 20° C., 22° C., 25° C., 30° C., 35° C., or 40° C.

In some embodiments, the total recoverable heat may be less than the total heat produced by the acid generating system 110. The recoverable heat may be determined by the temperature of the heat transfer process, the temperature of the heat source (e.g., the reactions occurring in acid burner 112 and/or acid absorber 116), and/or the temperature of heat transfer fluid 126. In some embodiments, multiple heat exchangers may be implemented in series to generate various heat transfer fluid temperatures. For example, acid burner 112 may have an operating temperature of 2400° C., and a heat transfer fluid comprising water may be flowed around, across, and/or through heat exchanger 124 and/or acid burner 112 to absorb the heat released (e.g., heat 122). In some embodiments, several heat exchangers in series may be used to generate heat transfer fluids 126 (e.g., steam streams) with different temperatures (e.g., 1700° C., 900° C., 500° C., etc.). These distinct heat transfer fluids 126 may be applied to heat different subsystems and/or process streams of system 100 to different temperatures.

In some embodiments, heat 122 generated by acid generating system 110 may be insufficient in quantity to fully execute a desired chemical reaction and/or process in system 100. Thus, heat 122 may be supplemented with additional heat generated by one or more of the following heat sources: (1) combustion of fossil fuels such as coal, oil, or natural gas, (2) combustion of hydrogen, (3) electric heating elements powered by electricity from an electric grid, photovoltaics, wind turbines, and/or other sources, (4) by concentrated solar power, and/or (5) other sources of heat.

In some embodiments, the output of acid generating system 110 may be provided as input to a wet solid generating system 128. In some embodiments, wet solids generating system 128 may comprise at least one dissolution chamber and at least one precipitation chamber. In some embodiments, the at least one dissolution chamber and the at least one precipitation chamber may be separate and not fluidically connected to one another. In some embodiments, the product (e.g., acid 120) of acid generating system 110 may be provided as input to the wet solid generating system (e.g., the dissolution chamber of wet solid generating system 128). In some embodiments, acid generating system 110 (e.g., acid absorber 116) may be fluidically connected to the wet solid generating system 128. In some embodiments, the acid generating system may be fluidically connected to a dissolution chamber of wet solids generating system 128. In addition to acid 120, the wet solid generating system 128 (e.g., the dissolution chamber of the wet solid generating system) may be configured to receive a first calcium source (e.g., calcium oxide, calcium hydroxide, calcium carbonate, and/or other sources of calcium). In some embodiments, the wet solid generating system may be configured to additionally or instead receive a silica source (e.g., calcium silicate (Ca₂O₄Si), aluminosilicates, clay, pozzolans, basalt, wollastonite, sand, and/or other sources of silica). In some embodiments, the calcium source can also include a silica source. In addition to the aforementioned materials, example calcium and/or silica sources may include but are not limited to lime, lime dust, or lime kiln dust, cement kiln dust, slag from metal production (iron, steel, magnesium or copper), igneous or metamorphic rocks, and/or furnace ashes (coal, biomass, municipal solid waste, etc.).

In some embodiments, the wet solids generating system 128 (e.g., the dissolution chamber) may be configured to receive a first calcium source and produce an intermediate calcium source. For example, the wet solids generating system 128 (e.g., the dissolution chamber) may be configured to dissolve a first calcium source in the acid (e.g., received from acid generating system 110). An intermediate calcium source can be produced by dissolution of the first calcium source in the wet solids generating system. In some embodiments, the intermediate calcium source can be provided as a reactant for a precipitation reaction (e.g., provided to a precipitation chamber of the wet solids generating system), as described below. In the instance the first calcium source comprises calcium carbonate, the calcium carbonate and acid 120 (e.g., hydrochloric acid) may be reacted in the wet solid generating system (e.g., a dissolution chamber) to produce at least a calcium chloride (CaCl₂)) solution (e.g., intermediate calcium source), as shown in Equation 12 below.

$${CaCO}_{3} + 2 HCl \to {CaCl}_{2} + {CO}_{2} + {H}_{2} O \qquad Eq . 12$$

As mentioned above, in some embodiments a silica source may be provided to acid generating system 110 (e.g., the dissolution chamber). Acid generating system may be configured to dissolve at least a portion of the silica source using acid 120 to generate a wet solid comprising a pozzolan source. In some embodiments, the inputs provided to acid generating system 110 may comprise a silica source and a calcium source. Thus, acid generating system 110 may produce an intermediate calcium source in addition to a wet solid (e.g., comprising a pozzolan source) (via dissolution). For example, calcium silicate (e.g., first calcium source) and hydrochloric acid may be reacted in the dissolution chamber to produce at least calcium chloride (e.g., intermediate calcium source) and silicon dioxide (e.g., SiO₂). The wet solid comprising a pozzolan source (e.g., silicate, SiO₂, etc.) from the dissolution chamber of wet solid generating system 128 may be provided to a dryer of system 100, as will be described in greater detail below.

As mentioned above, wet solids generating system 128 may additionally comprise a precipitation chamber. In some embodiments, the precipitation chamber may be fluidically connected to the dissolution chamber such that an output of the dissolution chamber (e.g., an intermediate calcium source, such as calcium chloride, etc.) may be provided as input to the precipitation chamber. In some embodiments, the precipitation chamber is not fluidically connected to the dissolution chamber such that the outputs from the dissolution chamber can be provided to the precipitation chamber in a batch-wise fashion. In some embodiments, the wet solid generating system (e.g., the precipitation chamber of wet solids generating system 128) may be configured to precipitate a second calcium source using the dissolved first calcium source (e.g., the intermediate calcium source) and a base 130 (e.g., sodium hydroxide (NaOH)). In some embodiments, wet solid generating system 128 (e.g., the precipitation chamber) may be fluidically connected to electrolyzer 106 (described above), such that the base product 130 of the electrolyzer may be provided as an input to the wet solid generating system 128. In the instance the salt 102 provided to electrolyzer 106 comprises sodium chloride and/or potassium chloride, base 130 may comprise sodium hydroxide and/or potassium hydroxide, respectively. In some examples, the intermediate calcium source from the dissolution chamber of the wet solid generating system 128 may comprise a calcium chloride product, and the base (e.g., sodium hydroxide, potassium hydroxide, etc.) and calcium chloride may be reacted to produce a second calcium source comprising calcium hydroxide (Ca(OH)₂), as shown below in Equation 13.

$${CaCl}_{2} + 2 NaOH \to {Ca ( OH )}_{2} + 2 NaCl \qquad Eq . 13$$

In some embodiments, a wet solid 132 may be generated from dissolving the first calcium source in the acid and/or precipitating the second calcium source using the dissolved first calcium source. In some embodiments, a wet solid 132 may be generated from dissolving the first calcium source in the acid and/or precipitating the second calcium source using a intermediate calcium source formed from dissolution in acid. Wet solid 132 may be a mixture comprising liquids and solids, such as a slurry, filter cake, chunk, film, etc. As mentioned above, in addition to or instead of a wet solid 132 comprising a second calcium source, wet solid generating system 128 may produce an additional wet solid 132 comprising a pozzolan source (e.g., silicate). In some embodiments, the one or more wet solids 132 produced by wet solid generating system 128 can include a calcium source and/or pozzolan source including but not limited to calcium hydroxide, amorphous silica, amorphous aluminosilicate, aluminum hydroxide, and/or aluminum oxide. Thus, wet solid generating system 128 may generate one or more wet solids (e.g., a wet solid comprising at least a second calcium source, a wet solid comprising at least a pozzolan source, etc.). For example, a dissolution chamber of wet solid generating system 128 may produce an intermediate calcium source and/or a wet solid comprising a pozzolan source, and a precipitation chamber may produce a wet solid comprising a second calcium source.

In some embodiments, the wet solid 132 can be dehydrated, dried, and/or sintered for later use. Wet solids generating system 128 may be configured to provide wet solid 132 to a dryer 134, and the dryer 134 may be configured to output a dried, dehydrated, and/or sintered product 136. For example, in the instance wet solid 132 comprises calcium hydroxide, product 136 may comprise dried calcium hydroxide. In another example, wet solid 132 may be a product stream from wet solid generating system 128 (e.g., a dissolution chamber) comprising a pozzolan source, and thus product 136 may comprise dried pozzolan.

In some embodiments, at least a portion of the liquid may be removed from wet solid 132 prior to providing wet solid 132 to dryer 134. For example, wet solid 132 may be a slurry that may be mechanically dewatered using a filter press, screw press, etc. to produce a filter cake. The resultant product may be provided to dryer 134 for drying. In addition to or instead of filtering wet solid 132, wet solid 132 may be washed (e.g., with a water source) prior to providing wet solid 132 to dryer 134. For example, wet solid 132 may be washed to remove residual byproduct (e.g., brine) from the wet solid 132.

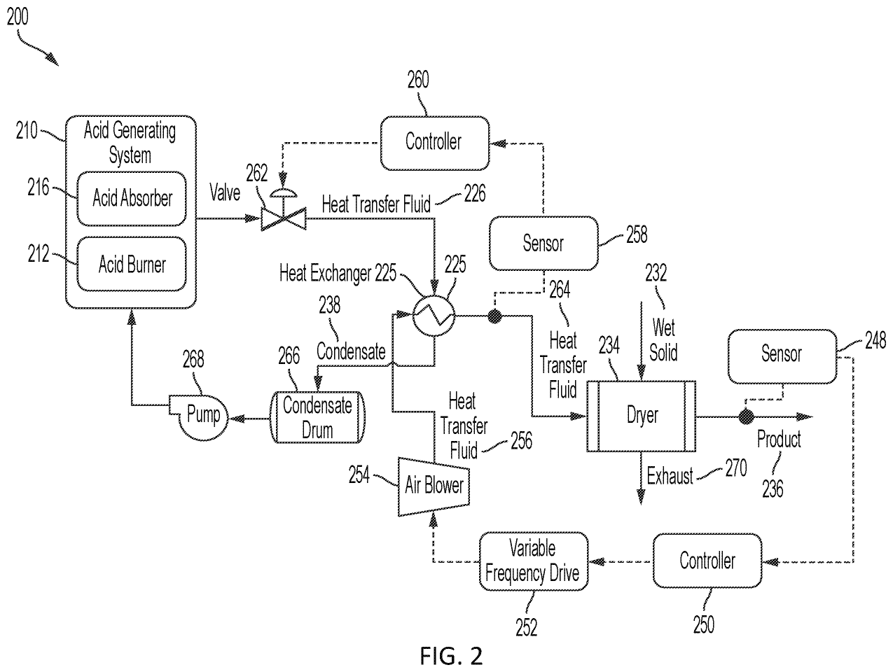

Dryer 134 may be configured to dry wet solid 132 (e.g., comprising a second calcium source and/or a pozzolan source) using heat from the acid generating system 110 to generate product 136. For example, dryer 134 may be configured to dry the wet solid 132 using heat from one or more heat transfer fluids 126. As illustrated in FIG. 1A, acid generating system 110 may be configured to provide heat transfer fluid 126 generated by heat exchanger 124 or a heat exchanger outside of acid generating system may be configured to provide heat transfer fluid to dryer 134. For example, acid generating system 110 (e.g., heat exchanger 124) may be fluidically connected to one or more subsystems of system 100, such as dryer 134. Heat transfer fluid 126 may be a liquid, gas, vapor, etc. (e.g., air) configured to transfer heat to dryer 134. Dryer 134 may use heat transfer fluid 126 to transfer the heat from heat transfer fluid 126 to wet solid 132, thereby drying (e.g., removing water from) wet solid 132. As will be described in greater detail below with respect to FIG. 2, using heat transfer fluid 126 may generate excess condensate 138, which may be provided to acid generating system 110 (e.g., to heat exchanger 124) and utilized by the system as boiler feed water and/or as a component of heat transfer fluid 126 to drive one or more processes executed in acid generating system 110.

In some embodiments, product 136 (e.g., calcium hydroxide, pozzolan, etc.) may be a single cementitious material, a component in a cementitious mixture, and/or a feedstock for further processing to produce a cementitious material. For example, product 136 may be a dry solid powder, filter cake, chunk, and/or film. In the instance product 136 comprises calcium hydroxide and/or pozzolan, the calcium hydroxide and/or pozzolan may be used in materials such as cement, mortar, or concrete, and/or other construction materials.

As mentioned above, system 100 may include chemical process equipment such as acid burner 112 and/or acid absorber 116 configured to react hydrogen and chloride to generate hydrochloric acid, and this equipment may release heat due to the exothermic enthalpy of reaction and/or the enthalpy change associated with the process of dilution. In addition, as mentioned above, the product 136 of system 100 may be calcium hydroxide. Therefore, in some embodiments, the amount of heat released by acid generating system 110 may be calculated on a calcium hydroxide molar basis and/or mass basis. In some embodiments, less than or equal to 290 kJ, 295 kJ, 300 kJ, 305 kJ, 310 kJ, 315 kJ, 320 kJ, or 235 kJ of heat may be released from the hydrochloric acid generation per 1 mol of calcium hydroxide. In some embodiments, greater than or equal to 290 kJ, 295 kJ, 300 kJ, 305 kJ, 310 kJ, 315 kJ, 320 kJ, or 235 kJ of heat may be released from the hydrochloric acid generation per 1 mol of calcium hydroxide. For example, about 306 kJ of heat may be released from the hydrochloric acid generation per 1 mol of calcium hydroxide. Likewise, in some embodiments, less than or equal to 4,000 kJ, 4,050 kJ, 4,100 kJ, 4,150 kJ, 4,200 kJ, or 4,250 kJ of heat may be released from the hydrochloric acid generation per 1 kg of calcium hydroxide. In some embodiments, greater than or equal to 4,000 kJ, 4,050 kJ, 4,100 kJ, 4,150 kJ, 4,200 kJ, or 4,250 kJ of heat may be released from the hydrochloric acid generation per 1 kg of calcium hydroxide. For example, about 4,136 kJ of heat may be released from the hydrochloric acid generation per 1 kg of calcium hydroxide produced.

Returning to the wet solids generating system 128, as shown in FIG. 1A, the wet solids generating system 128 (e.g., the precipitation chamber) may produce an additional product of brine 140 (e.g., brine comprising sodium chloride in Equation 13 above). In some embodiments, brine 140 may be recycled for use by electrolyzer 106. For example, in the instance brine 140 comprises sodium chloride, the brine 140 may be used to generate additional base 130 and/or acid 120. For example, the wet solids generating system (e.g., a precipitation chamber of wet solids generating system 128) may be fluidically connected to electrolyzer 106, such that brine 140 from the precipitation chamber may be provided as an input to electrolyzer 106. In some embodiments, brine 140 may be an aqueous solution and may be fed to an evaporator 142 (prior to electrolyzer 106). For example, FIG. 1A illustrates evaporator 142 fluidically connected between wet solids generating system 128 and electrolyzer 106. In some embodiments, evaporator 142 may be configured to remove excess solvent 144 (e.g., water) from brine 140 to provide a concentrated brine solution 146. Like brine 140, concentrated brine 146 may be used to generate additional base (e.g., hydroxide) and/or acid.

FIGS. 1B-1C illustrate additional block diagrams of system 100 for using heat produced from acid generation, in accordance with some embodiments. For example, FIG. 1B illustrates a system 100 in which the heat transfer fluid 126 may be provided to evaporator 142, and evaporator 142 may use the heat transfer fluid 126 to remove excess solvent (e.g., water) from brine 140. Thus, acid generating system 110 (e.g., at heat exchanger 124) may be fluidically connected to evaporator 142. Evaporator 142 may use heat transfer fluid 126 to transfer the heat carried by heat transfer fluid 126 to brine 140, thus evaporating the solvent from brine 140 using the heat and thereby concentrating the brine (e.g., producing concentrated brine 146). At least a portion of the fluid (e.g., condensate 138) produced from using heat transfer fluid 126 may be recycled and provided back to acid generating system 110. For example, heat transfer fluid 126 can be steam leaving the acid generating system. Once the heat of the steam is transferred to another subcomponent, subsystem, or part of the overall system, the steam may condense to water which is then recycled back to the acid generating system for additional steam generation.

In some embodiments, evaporator 142 may additionally or instead produce solvent (e.g., water) 144 which may not be recycled as condensate 138 for acid generating system 110. It is to be understood that system 100 illustrated with respect to FIG. 1B may comprise any one or more features of system 100 described with respect to FIG. 1A and not otherwise explicitly stated.

FIG. 1C illustrates a system 100 in which the heat transfer fluid 126 may be provided to each of dryer 134 and evaporator 142. In some embodiments, the heat transfer fluid 126 provided to each of dryer 134 and evaporator 142 may be the same temperature and/or type of fluid. In some embodiments, the type of fluid and/or temperature of the heat transfer fluid 126 may be different for the dryer 134 and evaporator 142. Thus, system 100 may comprise additional flow streams of heat transfer fluid 126 for each of the subsystems dryer 134 and evaporator 142. It is to be understood that system 100 illustrated in FIG. 1C may comprise any one or more features described above with respect to FIGS. 1A-1B. For example, each of dryer 134 and/or evaporator 142 illustrated in FIG. 1C may use heat transfer fluid 126 to transfer the heat from heat transfer fluid 126 to wet solid 132 and/or brine 140, respectively. In some embodiments, heat transfer fluid 126 may be provided to one or more subsystems of system 100 not otherwise explicitly stated herein. For example, in the instance system 100 comprises at least a portion of a cement production process, heat transfer fluid 126 may be provided to various other subsystems (e.g., process streams) of the cement production process that may require heat. Various example uses of heat produced in acid generation will be described in greater detail below.

In some embodiments, product 136, products comprising product 136 (e.g., cement, mortar, concrete, etc.), systems used to produce product 136, and/or systems used to produce products comprising product 136 may be carbon-neutral or carbon-negative. For example, the carbon intensity may be less than or equal to 0 tons of carbon dioxide emitted per ton of cement (ton CO₂/ton cement), less than 0.1, 0.2, 0.3, 0.4, 0.5, 0.6 ton CO₂/ton cement.

In some embodiments, product 136, products comprising product 136 (e.g., cement, mortar, concrete, etc.), systems used to produce product 136, and/or systems used to produce products comprising product 136 may comprise a reduced-carbon footprint. For example, in the instance product 136 comprises a component of cement (e.g., calcium hydroxide), the calcium hydroxide product, the system used to generate the calcium hydroxide, the cement product comprising the calcium hydroxide, and/or the system used to generate the cement product may comprise a smaller carbon footprint relative to an ordinary cement composition. In some embodiments, the reduced-carbon footprint may have less than 75%, 50%, 40%, 30%, 25%, 20%, 10%, or 5% of the carbon footprint as the ordinary cement composition. In some embodiments, the reduced-carbon footprint may be a neutral carbon footprint or a negative carbon footprint.

In some embodiments, the negative carbon footprint may be less than 600, 500, 400, 300, 200, 100, 50, 25, 10, or 0 kg CO₂/m³ of product 136 and/or a product comprising product 136 (e.g., cement, mortar, concrete, etc.).

In some embodiments, system 100 may comprise additional modules (e.g., systems, subsystems, process streams, etc.) not explicitly illustrated in FIGS. 1A-1C. In addition, one or more modules described above may be omitted, combined, and/or embodied in a manner different from as described above. For example, as mentioned above, system 100 may comprise additional heat exchangers 124. Each of the one or more heat exchangers 124 may be provided as a module in acid generating system 110 and/or may be disposed outside of acid generating system 110.

One or more systems illustrated in FIGS. 1A-1C may be described herein as connected (e.g., fluidically connected). However, it is to be understood that this representation is merely an example, and each of the above-described modules (e.g., systems, subsystems, process streams, etc.) may standalone. In other words, one or more of the modules of system 100 may be isolated and thus may not be physically connected to one or more remaining modules of system 100 for reactants, products, fluids, etc. to be transferred within the system.

It is to be understood that system 100 may be a standalone system, may be integrated as a subsystem to a larger system, and/or may be combined with one or more systems. For example, as mentioned above, the product 136 of system 100 may be a cement product and/or may be combined with one or more cementitious components to generate a cement product.

Example Uses of Heat Produced from Acid Generation

As mentioned above, the heat produced from acid generation may be used for operations including the production, processing, drying, and/or vaporization of various construction materials. More specifically, the heat may be used for drying, calcining, and/or reacting materials such as limestone, calcium hydroxide, clays, and/or other cement materials. For example, the heat may be used for drying wet solids (e.g., a calcium source, silica source, etc.), evaporating one or more components of solution/suspension produced in making cement, drying feedstock streams, calcination of limestone to produce quicklime, calcination of clay for pozzolan production, calcination of calcium hydroxide for cement production, reaction of lime with silica to form alite, and/or reaction of limestone, clay, and sand to form Portland cement clinker, each of which will be described in greater detail below.

### Example 1. Drying Wet Solids

As mentioned above, the heat produced from acid generation may be used in various subsystems of system 100, such as for drying a wet solid. FIG. 2 illustrates a process diagram of a system 200 for using heat produced by an acid generating system to dry a wet solid, such as a wet solid comprising a calcium source and/or silica source.

As shown in FIG. 2, a wet solid 232 may be dried in dryer 234 using a heat transfer fluid 264 generated using heat produced by acid generating system 210. In some embodiments, a stream of wet solid 232 may have a moisture content less than or equal to 5%, 10%, 15%, 20%, 25%, 30%, 35%, or 40%. In some embodiments, wet solid 232 may have a moisture content greater than or equal to 5%, 10%, 15%, 20%, 25%, 30%, 35%, or 40%. Wet solid 232 may comprise any one or more features of wet solid 132 described above with respect to FIGS. 1A-1C.

As mentioned above, wet solid 232 may be dried via dryer 234. In some embodiments, dryer 234 may be any industrial hot air solids dryer that utilizes air as a heat transfer medium, including but not limited to a fluidized bed dryer, vibratory fluidized bed dryer, Tornesh dryer, and/or bulk flow heater. The air may be provided to dry the product at a temperature less than or equal to 100° C., 125° C., 150° C., 175° C., or 200° C. In some embodiments, the temperature of the air may be greater than or equal to 100° C., 125° C., 150° C., 175° C., or 200° C. In some embodiments, the moisture content of product 236 may be greater than or equal to 0.1%, 0.25%, 0.5%, 0.75%, 1%, 1.5%, 2%, 2.5%, 5%, 7.5%, or 10%. In some embodiments, the moisture content of product 236 may be less than or equal to 0.1%, 0.25%, 0.5%, 0.75%, 1%, 1.5%, 2%, 2.5%, 5%, 7.5%, or 10%. In some embodiments, the temperature for drying may be at least 100° C. (i.e., the boiling point of water at 1 atm pressure). It may be determined that the heat from acid generation may have a temperature far above 100° C., which would enable at least a portion of the heat to be used for removing water from the wet solid.

To provide heat to dryer 234, a heat transfer fluid 256 (e.g., stream of air 256) may be provided to a heat exchanger 225 from an air blower 254. In some embodiments, the air blower 254 and heat exchanger 225 may be fluidically connected. In some embodiments, heat exchanger 225 may comprise any one or more features of heat exchanger 124 described above with respect to FIGS. 1A-1C. For example, the design of heat exchanger 225 may include a shell and tube, pipe in pipe, spiral, and/or plate and frame style heat exchanger. Although heat exchanger 225 is illustrated in FIG. 2 as external to acid generating system 210, it is to be understood that heat exchanger 225 may, in some embodiments, be disposed internal to acid generating system 210. Moreover, it is to be understood that system 200 may comprise more than one heat exchanger, as mentioned above with respect to heat exchanger 124 and FIGS. 1A-1C. For example, system 200 may comprise a first heat exchanger disposed inside acid generating system 210 (e.g., heat exchanger 124 illustrated in FIGS. 1A-1C) and a second heat exchanger disposed outside acid generating system 210 (e.g., heat exchanger 225 illustrated in FIG. 2). Heat transfer fluid 256 (e.g., air) may be heated by heat exchanger 225 to generate a heated air stream (e.g., heat transfer fluid 264). The heat transfer fluids can be any fluids described herein. As mentioned above, the heat transfer fluid 264 (e.g., heated air) may be provided at a temperature less than or equal to 100° C., 125° C., 150° C., 175° C., or 200° C. In some embodiments, heat transfer fluid 264 may be provided at a temperature greater than or equal to 100° C., 125° C., 150° C., 175° C., or 200° C.

A first heat transfer fluid 226 (e.g., steam) may be utilized to heat a heat transfer fluid 256 (e.g., air) provided to heat exchanger 225. Heat transfer fluid 226 may be generated by acid generating system 210. Acid generating system 210 may comprise any one or more features of acid generating system 110 described above with respect to FIGS. 1A-IC. For example, acid generating system 210 may comprise an acid burner 212 and/or acid absorber 216. In some embodiments, acid burner 212 and acid absorber 216 may be configured to synthesize an acid. The acid burner 212 and/or acid absorber 216 may comprise any known acid burner design, including but not limited to a top burner design, bottom burner design, etc. As mentioned above, acid generating system 210 may comprise a heat exchanger (e.g., in addition to heat exchanger 225) disposed inside of acid generating system 210. This heat exchanger (e.g., first heat exchanger) may be configured to provide heat transfer fluid 226 (e.g., a first heat transfer fluid) to heat exchanger 225 (e.g., second heat exchanger). Heat exchanger 225 may use heat transfer fluid 226 to transfer heat from first heat transfer fluid 226 to intermediate heat transfer fluid 256 and produce second heat transfer fluid 264 (e.g., second heat transfer fluid). Dryer 234 may be configured to receive heat transfer fluid 264 (e.g., second heat transfer fluid) and dry wet solid 232 using heat from the second heat transfer fluid 264.

Heat exchanger 225 may generate a condensate 238 when heat transfer fluid 256 is heated. Condensate 238 may be captured in a condensate drum 266 and returned to acid generating system 210 using a pump 268 (e.g., a centrifugal pump). Condensate 238 may comprise any one or more features of condensate 138 described above with respect to FIGS. 1A-1C. For example, condensate 238 may be reused as boiler feed water in acid generating system 210.

System 200 may comprise a control system configured to modulate one or more subsystems, modules, process streams, etc. of system 200. In some embodiments, the control system of system 200 may comprise one or more sensors that may determine one or more properties of fluids, products, etc. in system 200. For example, system 200 may comprise one or more sensors 248 configured to measure one or more properties of product 236. In some embodiments, sensor 248 may comprise a moisture sensor, temperature sensor, resistance sensor, impedance sensor, etc., or combinations thereof. In some embodiments, sensor 248 may comprise a plurality of sensors, each sensor configured to measure one or more properties of product 236 (e.g., a dried wet solid). Sensor 248 may be disposed at the inside and/or outlet of dryer 234 and may be communicatively coupled to a controller 250. Sensor 248 may be configured to continuously measure one or more properties of product 236 (e.g., moisture content) and may provide data to controller 250, wherein the controller can be configured to modify one or more components of the system based on the data.

In some embodiments, sensor 248 may be a moisture sensor configured to determine the moisture content of product 236. Based on a determination that the moisture content of product 236 is outside of a desired range (e.g., threshold), sensor 248 may be configured to provide one or more signals to controller 250. In some embodiments, a lower end of a threshold range of moisture may be less than or equal to 0.05%, 0.1%, 0.15%, 0.2%, 0.3%, 0.4%, 0.5%, 0.6%, 0.7%, 0.8%, 0.9%, or 1.0%. In some embodiments, a lower end of a threshold range of moisture may be greater than or equal to 0.05%, 0.1%, 0.15%, 0.2%, 0.3%, 0.4%, 0.5%, 0.6%, 0.7%, 0.8%, 0.9%, or 1.0%. In some embodiments, an upper end of a threshold range of moisture may be less than or equal to 0.5%, 1%, 2%, 3%, 4%, 5%, 6%, 7%, 8%, 9%, 10%, 11%, 12%, 13%, 14%, or 15%. In some embodiments, an upper end of a threshold range of moisture may be greater than or equal to 0.5%, 1%, 2%, 3%, 4%, 5%, 6%, 7%, 8%, 9%, 10%, 11%, 12%, 13%, 14%, or 15%.

In some embodiments, the controller may comprise one or more of a controller 250, variable frequency drive 252, and/or air blower 254 configured to adjust the flow of a heat transfer fluid to a component of the system (e.g., dryer, evaporator, etc.) based on a determination that the measured property of fluids, products, etc. (e.g., the dried wet solid product 236) in system 200 is outside of a threshold range. In some embodiments, the controller can be a flow controller configured to adjust the flow of a heat transfer fluid to the dryer based on a determination that the measured property of the dried wet solid is outside of a threshold range.

Continuing with the above example of sensor 248 being a moisture sensor, in the instance the moisture content of product 236 is lower than the desired moisture content range, moisture sensor 248 may transmit a first signal to controller 250. In the instance the moisture content of product 236 is higher than the desired moisture content range, moisture sensor 248 may transmit a second signal to controller 250, wherein the second signal may be different from the first signal. Based on the received signals, controller 250 may be configured to control (e.g., provide instructions to) a variable frequency drive 252 to modulate the flow of heat transfer fluid 256 provided to dryer 234 via heat exchanger 225. For example, based on a determination that the moisture content is above a desired range, controller 250 may provide instructions to variable frequency drive 252 to increase the speed of blower 254, thereby providing an increased drying capacity. On the other hand, based on a determination that the moisture content is below a desired range, controller 250 may provide instructions to variable frequency drive 252 to decrease the speed of blower 254, thereby decreasing drying capacity. Thus, the desired moisture content of product 236 may be easily maintained using one or more of sensors 248, controller 250, and/or variable frequency drive 252. Likewise, extending to other properties that may be measured by one or more sensors 248, the desired properties of product 236 may be easily monitored and maintained using one or more of sensors 248, controller 250, and/or variable frequency drive 252.

In some embodiments, system 200 may comprise an additional sensor and controller loop configured to monitor one or more properties of a different process stream than described above with respect to sensor 248 and controller 250. In some embodiments, the system can include a controller comprising one or more of a controller 260 and/or valve 262 and configured to adjust the flow of a first heat transfer fluid to a heat exchanger based on a determination that the measured property of a second heat transfer fluid is outside of a threshold range. For example, system 200 may comprise a sensor 258 and controller 260 configured to measure one or more properties of heat transfer fluid 264. Sensor 258 and controller 260 may comprise any one or more properties of sensor 248 and controller 250, respectively, described above. For example, sensor 258 may comprise one or more temperature sensors configured to measure the temperature of heat transfer fluid 264. Sensor 258 may be disposed after heat exchanger 225 and thus may measure the temperature of heat transfer fluid 264 once heated by heat exchanger 225. Sensor 258 may be configured to transmit signals to controller 260 based on the measured temperatures of heat transfer fluid 264. In the instance sensor 258 comprises one or more temperature sensors, sensor 258 may transmit one or more signals to controller 260 based on a determination that the temperature of heat transfer fluid 264 is outside of a desired temperature range (e.g., threshold temperature range). In some embodiments, a lower end of the threshold temperature range may be less than or equal to 100° C., 110° C., 120° C., 130° C., 140° C., or 150° C. In some embodiments, a lower end of the threshold temperature range may be greater than or equal to 100° C., 110° C., 120° C., 130° C., 140° C., or 150° C. In some embodiments, an upper end of the threshold temperature range may be less than or equal to 150° C., 160° C., 170° C., 180° C., 190° C., or 200° C. In some embodiments, an upper end of the threshold temperature range may be greater than or equal to 150° C., 160° C., 170° C., 180° C., 190° C., or 200° C.

Sensor 258 may transmit a first signal to controller 260 based on a determination that the temperature is lower than a threshold temperature range. Likewise, sensor 258 may transmit a second signal to controller 260 based on a determination that the temperature is higher than a threshold temperature range, wherein the second signal may be different from the first signal. Based on the received signals, controller 260 may be configured to modulate the flow of heat transfer fluid 226 to heat exchanger 225 by controlling a valve 262. By controlling the valve, a steady hot temperature of heat transfer fluid 264 may be maintained. For example, in the instance the temperature of heat transfer fluid 264 is above a desired range, controller 260 may decrease the amount that valve 262 is open, thereby decreasing the amount of heat transfer fluid 226 that is provided to heat exchanger 225. On the other hand, in the instance the temperature of heat transfer fluid 264 is below a desired range, controller 260 may increase the amount that valve 262 is open, thereby increasing the amount of heat transfer fluid 226 provided to heat exchanger 225. Thus, the desired temperature of heat transfer fluid 264 may be easily maintained using one or more of sensors 258, controller 260, and/or valve 262. Likewise, extending to other properties that may be measured by one or more sensors 258, other the desired properties of heat transfer fluid 264 may be easily monitored and maintained using one or more of sensors 258, controller 260, and/or valve 262.

In some embodiments, system 200 may comprise additional modules (e.g., systems, subsystems, process streams, etc.) not explicitly illustrated in FIG. 2. In addition, one or more modules described above may be omitted, combined, and/or embodied in a manner different from as described above. For example, as mentioned above, system 200 may comprise additional heat exchangers. Each of the one or more heat exchangers may be provided as a module in acid generating system 210 and/or may be disposed outside of acid generating system 210.

Likewise, system 200 may comprise one or more additional sensors not explicitly described herein. For example, as mentioned above, system 200 may comprise additional sensors configured to measure one or more properties of heat transfer fluid 264 and/or product 236 in addition to or instead of the above-described properties. In some embodiments, system 200 may comprise sensors configured to measure properties of process streams not explicitly described above. For example, system 200 may comprise one or more sensors configured to measure properties of air 256, heat transfer fluid 226, etc.

In some embodiments, controller 250 and controller 260 may be combined such that the controller is configured to receive signals from various sensors (e.g., sensor 248, sensor 258, etc.) indicative of one or more measured properties of a stream (e.g., product 236, heat transfer fluid 226, etc.), process the signals, and transmit signals (e.g., instructions) to control one or more components (e.g., variable frequency drive 252, valve 262, etc.) based on the received signals. Controllers 250 and 260 may be communicatively coupled (e.g., wired and/or wirelessly) to one or more components of system 200. Controllers 250 and 260 may each include a single processor or may be architectures employing multiple processor designs for increased computing capability. Suitable processors include central processing units (CPUs), graphical processing units (GPUs), field programmable gate arrays (FPGAs), and application-specific integrated circuits (ASICs).

One or more systems illustrated in FIG. 2 may be described as connected (e.g., fluidically connected). However, it is to be understood that this representation is merely an example, and each of the above-described modules (e.g., systems, subsystems, process streams, etc.) of FIG. 2 may standalone. In other words, one or more of the modules of system 200 may be isolated and thus may not be physically connected to one or more remaining modules of system 200 for reactants, products, fluids, etc. to be transferred within the system.

It is to be understood that system 200 may be a standalone system, may be integrated as a subsystem to a larger system, and/or may be combined with one or more systems (e.g., system 100 described above with respect to FIGS. 1A-1C). For example, as mentioned above, the product 236 of system 200 may be a cement product and/or may be combined with one or more cementitious components to generate a cement product.

In one example use of system 200, a calcium hydroxide filter cake may be provided to have a water content of approximately 32 wt %, a solids content of approximately 68 wt %, and a starting temperature of approximately 35° C. The starting temperature may be above the ambient temperature due to the exothermic reactions of both the dissolution of the calcium source and the precipitation of the calcium hydroxide. To drive off the water and produce a dry calcium hydroxide solid, the filter cake may be heated to the water liquid-vapor phase transition at 1 atmosphere pressure of 100° C., and sufficient heat may be supplied to vaporize the water.

TABLE 1
Selected properties of water and calcium hydroxide
used to calculate drying energy.

| Material Property | Value | Unit |
|---|---|---|
| Heat capacity, water | 4.18 | kJ/kg K |
| Heat capacity, calcium hydroxide | 1.18 | kJ/kg K |
| Heat of vaporization, water | 2260 | kJ/kg |

Under the aforementioned conditions, the sensible heat used to raise 1 kg of the wet Ca(OH)₂ material from 35° C. to 100° C. may be approximately 139 kJ. In addition, the latent heat used to evaporate 0.32 kg H₂O from the 1 kg wet Ca(OH)₂ may be approximately 723 kJ. The total heat input used to dry 1 kg of wet Ca(OH)₂ may be 862 kJ. On the basis of dry Ca(OH) 2 mass, the drying process may require a thermodynamic minimum heat input of approximately 1240 KJ/kg of calcium hydroxide. The heat output of an acid generating system may be determined to be 2490 KJ/kg dry calcium hydroxide. Thus, the heat output from the acid generating system may be more than sufficient to fully dry the wet calcium hydroxide filter cake.

In another example use of system 200, a flow of 10,000 kg/hr of calcium hydroxide cake at 75% moisture content (e.g., 7,500 kg/hr CaOH and 2,500 kg/hr water) and 50° C. may be provided. The system requirements for the dried calcium hydroxide may be 1% moisture content, which results in a product flow of approximately 7,576 kg/hr. Based on parameters provided in Table 2a below (e.g., the latent of water, heat capacity of water, heat capacity of calcium hydroxide, and latent heat of saturated steam) and an estimated dryer thermal efficiency of 60% (which may vary), the flow of a first heat transfer fluid (e.g., steam) may be determined as 5,326 kg/hr at a temperature of 184° C., as shown below in Equations 14a-14f.

$$Steam Flow Rate = \frac{Actual Heat Requirement}{Saturated Steam Latent Heat} \qquad Eq . 14 a$$

$$Actual Heat Requirement = \frac{Total Theoretical Heat Requirement}{Thermal efficiency} \qquad Eq . 14 b$$

$$Total Theoretical Heat Requirement = Water Evaporation + Water Sensible Heat + CaOH Sensible Heat \qquad Eq . 14 c$$

$$Water Evaporation = ( Water {Flow}_{in} - Water {Flow}_{out} ) * Water Latent Heat \qquad Eq . 14 d$$

$$Water Sensible Heat = Water {Flow}_{in} * Water Heat Capacity * ( Flow {Temperature}_{out} - Flow {Temperature}_{in} ) \qquad Eq . 14 e$$

$$CaOH Sensible Heat = CaOH {Flow}_{in} * CaOH Heat Capacity * ( Flow {Temperature}_{out} - Flow {Temperature}_{in} ) \qquad Eq . 14 f$$

TABLE 2a
Selected properties of water and CaOH used
to calculate heat transfer fluid flow.

| Material Property | Value | Unit |
|---|---|---|
| Latent heat, water | 2256 | kJ/kg at |
| | | 100° C. |
| Heat capacity, water | 4.18 | kJ/kg-° C. |
| Heat capacity, CaOH | 1.18 | kJ/kg-° C. |
| Latent heat, saturated steam | 2013.56 | kJ/kg-° C. at |
| | | 10 barg |

In addition, with a known water removal rate of about 2,424 kg/hr, the flow rate of a second heat transfer fluid (e.g., hot air) may be determined for a given air temperature using the moisture carrying capacity of air. For example, with a hot air stream at 60° C., the hot air flow rate provided to dryer may be about 18,648 m³/hr, as shown below in Equation 14g and using the parameter provided in Table 2b.

$$Hot Air Flow Rate = \frac{Water {Flow}_{in} - Water {Flow}_{out}}{Air Moisture Carrying Capacity} \qquad Eq . 14 g$$

TABLE 2b
Selected properties of water and steam
used to calculate drying energy.

| Material Property | Value | Unit |
|---|---|---|
| Carrying capacity, air | 130 | g/m³ |

In the above example, valve 262 may be provided with a flow coefficient range equating to between 4,200 kg/hr and 6,700 kg/hr, which may provide temperature controller 260 with a proper range to maintain steady temperature control of system 200. In addition, air blower 254 and variable frequency drive 252 may be provided with a range of air flows equating to between 15,000 m³/hr and 23,500 m³/hr, which may provide controller 250 with a proper range to maintain steady moisture content control of product 236.

Based on the above example system 200, the cost savings of reusing heat produced from acid generation for drying in comparison to electrical drying may be determined. For example, as shown above, the heat requirement of dryer 234 (Equation 14b) may be determined based on the estimated thermal efficiency of the dryer (e.g., 60%), water evaporation (Equation 14d above), the sensible heat of water (Equation 14e above), and the sensible heat of calcium hydroxide (Equation 14f above) to be about 2,979 kW. Using the heat requirement of dryer 234, the example flow of product 236 (e.g., calcium hydroxide cake, 10,000 kg/hr), and an estimated cost of electricity, the cost savings may be determined to be approximately $29.79/ton of product, as shown below in Equation 15a.

$$Cost Savings = \frac{Actual Heat Requirement * Electricity Cost}{Total Flow} \qquad Eq . 15 a$$

TABLE 3a
Selected parameters used to calculate drying savings.

| Parameter | Value | Unit |
|---|---|---|
| Cost, electricity | 0.10 | $/kW-hr |

In addition to cost savings, the amount of carbon dioxide that may be reduced by reusing heat from acid generation in comparison to an electrical drying system may be determined. For example, the heat requirement of dryer 234 (described above with respect to the cost savings calculation), the example flow of the product (e.g., calcium hydroxide cake, 10,000 kg/hr), and an estimated US grid average CO₂ intensity may be used to determine an approximate CO₂ reduction of about 0.13 tonnes CO₂/ton of product compared to heat generated by an electrical drying system, as shown below in Equation 15b.

$${CO}_{2} Reduction = \frac{Actual Heat Requirement * US Grid Average {CO}_{2} Intensity}{Total Flow} \qquad Eq . 15 b$$

TABLE 3b
Selected parameters used to calculate drying savings.

| Parameter | Value | Unit |
|---|---|---|
| US grid average CO₂ Intensity | 0.45 | kg CO₂/kW-hr |

In some embodiments, the approximate CO₂ reduction in a system using heat produced by acid generation in drying/evaporating in comparison to an electrical drying system may be less than 0.13 tonnes CO₂/ton of product, such as 0.01, 0.02, 0.03, 0.04, 0.05, 0.06, 0.07, 0.08, 0.09, 0.1, 0.11, or 0.12 tonnes CO₂/ton of product. In some embodiments, the approximate CO₂ reduction may be greater than 0.13 tonnes CO₂/ton of product, such as 0.14, 0.15, 0.16, 0.17, 0.18, 0.19, 0.2, 0.25, 0.3, 0.4, 0.5, or more tonnes CO₂/ton of product.

Moreover, by reusing heat from acid generation rather than using electricity to generate heat, the efficiency of the system (e.g., the amount of energy expended) may be reduced. The energy consumption of the system may be determined by considering the energy consumption of various components of the system, such as the electrolyzer (e.g., electrolyzer 106) and the dryer (e.g., dryer 234). As described above, the heat requirement of dryer 234 may be determined using the estimated thermal efficiency of the dryer (e.g., 60%), water evaporation (Equation 14d above), the sensible heat of water (Equation 14e above), and the sensible heat of calcium hydroxide (Equation 14f above) to be about 2,979 KW, or about 297 kW-hr/tonne Ca(OH)₂ based on a flow of calcium hydroxide of 10,000 kg/hr. Based on an estimated energy consumption of 2105 kW-hr/tonne Ca(OH)₂ for electrolyzer 106, the total energy input of the system may be estimated to be about 2403 kW-hr/tonne Ca(OH)₂. Therefore, energy savings may be about 12%, determined as shown below in Equation 15c.

$$Energy Savings = \frac{Drying Heat Requirement}{Total Energy Input} \qquad Eq . 15 c$$

TABLE 3c
Selected parameters used to calculate energy savings.

| Parameter | Value | Unit |
|---|---|---|
| Electrolyzer electricity use | 2105 | kW-hr/ton CO₂ |

In some embodiments, energy savings for a system using heat produced from acid generation may be less than or equal to about 12% in comparison to alternative energy sources (e.g., electricity, fossil fuels, etc.), such as 1%, 2%, 3%, 4%, 5%, 6%, 7%, 8%, 9%, 10%, or 11%. In some embodiments, energy savings for a system using heat produced from acid generation may be greater than or equal to 12% in comparison to alternative energy sources, such as 13%, 14%, 15%, 20%, 25%, 30%, 35%, 40%, 45%, 50%, or more.

### Example 2. Evaporating Coproducts of the Wet Solid Generating System

As described above with respect to FIGS. 1B-1C, the heat produced from acid generation may be applied towards evaporation subsystems of a cement product generation system. For example, an evaporator may be configured to receive a coproduct (e.g., brine) from a wet solid generating system and may remove water content from the brine to produce a concentrated brine product. For example, in the instance a calcium hydroxide wet solid is produced by the wet solid generating system, the brine provided to an evaporator may comprise primarily sodium chloride (NaCl). The evaporator may be configured to receive heat generated by an acid generating system (e.g., via a heat transfer fluid) and use the heat to remove fluids such as water from the sodium chloride, thereby producing a concentrated sodium chloride product. The concentrated brine may be provided to an electrolyzer (e.g., electrolyzer 106) to produce additional hydrogen and chlorine. In some embodiments, the condensate produced from using the heat transferred from the heat transfer fluid may be recycled back to the acid generating system, as described above.

### Example 3. Drying Feed Streams

In some embodiments, the heat from an acid generating system may be used to dry any feed stream or input into a cement making process that has residual moisture or water such as coal ash or mining tailings. Mining tailings could include silicates, aluminosilicates, magnesium silicate, or calcium silicates from the mining of transition metals, precious metals, boron, asbestos or other materials where silicates or aluminosilicates are discarded. Coal ash may comprise bottom ash, fly ash, economizer ash, and/or ponded ash (e.g., ponded coal fly ash). The feed stream may instead or additionally comprise lime, lime dust, or lime kiln dust, cement kiln dust, slag from metal production (iron, steel, magnesium or copper), igneous or metamorphic rocks, and/or furnace ashes (coal, biomass, municipal solid waste, etc.). The feed stream to be dried may be a filter cake, slurry, paste, or other form of ash wherein solid aluminosilicates are mixed with water. Coal ash may be a supplementary cementitious material that is a byproduct of the coal industry. Coal ash may comprise of a specified content of amorphous glass comprising SiO₂, Al₂O₃, Fe₂O₃, and/or other oxides, a specified content of carbon, and a specified content of crystalline oxides comprising SiO₂, Al₂O₃, and/or Fe₂O₃. In some markets, the current production of coal ash may match its consumption in construction, with more demand being driven by the awareness that supplementary cementitious materials may improve cement durability and may reduce the emissions of cement without compromising strength.

As mentioned above, the coal ash supply may be ponded, which may comprise mixing the coal ash with water and pouring it into a reservoir (e.g., in an effort to capture and contain the byproduct). In some embodiments, coal ashes may be landfilled and mixed with water from the environment such as ambient humidity, rain, and/or groundwater. As described above with regards to coal ash, the ponded coal ash slurry may be of interest for the supplementary cementitious materials market. In some embodiments, a ponded coal ash slurry may be converted into free-flowing, dry coal ash. For example, the slurry may be converted into dry coal ash by evaporation of the water in the ponded coal ash slurry. Thus, as described above at least with respect to drying wet solids products of a wet solid generating system, the heat to evaporate the water from the coal ash slurry may be provided by an acid generating system.

TABLE 4
Selected properties of water and fly
ash used to calculate drying energy.

| Material Property | Value | Unit |
|---|---|---|
| Heat capacity, water | 4.18 | kJ/kg-K |
| Heat capacity, fly ash | 0.95 | kJ/kg-K |
| Heat of vaporization, water | 2260 | kJ/kg |

In some embodiments, the coal ash slurry may comprise of 32 wt % water and 68 wt % coal ash. The heat for drying may be determined using the heat capacity of the water, the heat capacity of the fly ash, and the heat of vaporization of the water to be about 852 KJ/kg of slurry. Stated otherwise, the heat for drying may be about 1253 KJ/kg of dry coal ash powder. In some embodiments, the heat from the acid generating system may be sufficient to convert 2.92 kg of fly ash slurry into 1.98 kg of dry fly ash per 1 kg of dry calcium hydroxide, produced as described above at least with respect to FIGS. 1A-1C.

### Example 4. Calcination of Limestone (CaCO₃) to Make Quicklime (CaO)

In some embodiments, the heat released from the acid generating system may be used for production of quicklime (CaO) via the calcination of limestone (calcium carbonate, CaCO₃) based on Equation 16 provided below.

$${CaCO}_{3} \to CaO + {CO}_{2} , ΔH = 178.3 kJ / mol \qquad Eq . 16$$

In some embodiments, the reaction may take place at a temperature of less than or equal to 700° C., 750° C., 800° C., 850° C., 900° C., 950° C., 1000° C., 1050° C., 1100° C., 1150° C., or 1200° C. In some embodiments, the reaction may take place at a temperature of greater than or equal to 700° C., 750° C., 800° C., 850° C., 900° C., 950° C., 1000° C., 1050° C., 1100° C., 1150° C., or 1200° C. For example, the reaction temperature may be about 900° C. In some embodiments, a heat input may be used to heat the starting material (calcium carbonate or limestone) from a starting temperature near 25° C. to a final temperature of 900° C., then subsequently drive the reaction provided in Equation 16 to create CaO. The specific heat capacity of calcium carbonate may be 0.834 KJ/kg·° C. The sensible heat used to increase the temperature of the limestone or calcium carbonate from 25° C. to 900° C. may be around 730 KJ/kg CaCO₃. The enthalpy of reaction (Equation 16) may be around 1781 KJ/kg CaCO₃. Thus, the thermodynamic minimum heat energy input requirement may be about 2511 KJ/kg CaCO₃. Based on the reaction stoichiometry of Equation 16, the reaction of 1 mol CaCO₃ may produce 1 mol CaO. Therefore, an input of 1 kg CaCO₃ may produce an output of 0.56 kg CaO. In some embodiments, the total thermodynamic minimum heat energy input requirement may be around 4490 KJ/kg CaO produced.

In some embodiments, the heat output of an acid generating system process may be 2490 KJ/kg dry calcium hydroxide. Therefore, the total heat output of the acid generating system may be sufficient to calcine approximately 0.99 kg CaCO₃ and produce approximately 0.55 kg CaO per 1 kg dry calcium hydroxide.

In some embodiments, it may not be possible to use all the heat released by the acid acid generating system, at least because the temperature may not be above 700° C., 750° C., 800° C., 850° C., 900° C., 950° C., 1000° C., 1050° C., 1100° C., 1150° C., or 1200° C. In some embodiments, it may not be possible to use all the heat released by the acid generating system due to heat loss to the environment and/or process inefficiency. In some embodiments, the heat output of the acid generating system may be enough to calcine less than or equal to 0.1 kg, 0.2 kg, 0.3 kg, 0.4 kg, 0.5 kg, 0.6 kg, 0.7 kg, 0.8 kg, or 0.9 kg CaCO₃ per 1 kg dry calcium hydroxide. In some embodiments, the heat output of the acid generating system may be enough to calcine greater than or equal to 0.1 kg, 0.2 kg, 0.3 kg, 0.4 kg, 0.5 kg, 0.6 kg, 0.7 kg, 0.8 kg, or 0.9 kg CaCO₃ per 1 kg dry calcium hydroxide. In some embodiments, the heat output of the acid generating system may be enough to produce less than or equal to 0.05 kg, 0.10 kg, 0.15 kg, 0.20 kg, 0.25 kg, 0.30 kg, 0.35 kg, 0.40 kg, 0.45 kg, or 0.50 kg CaO per 1 kg dry calcium hydroxide. In some embodiments, the heat output of the acid generating system may be enough to produce greater than or equal to 0.05 kg, 0.10 kg, 0.15 kg, 0.20 kg, 0.25 kg, 0.30 kg, 0.35 kg, 0.40 kg, 0.45 kg, or 0.50 kg CaO per 1 kg dry calcium hydroxide.

In some embodiments, the limestone and/or calcium carbonate may be calcined in a kiln or a flash calciner. The heat from the acid generating system may be conveyed to the equipment used for calcining the calcium carbonate and/or limestone via conduction, convection, and/or radiation. In some embodiments, the heat may be carried in a process stream comprising primarily a high temperature acid (e.g., hydrochloric acid). In some embodiments, a heat exchanger may be used to transfer the heat from the acid to a heat transfer fluid such as water, a solvent, and/or a molten salt, and this heat transfer fluid may heat the reactor used to calcine the limestone and/or calcium carbonate.

### Example 6. Calcination of Calcium Hydroxide ((Ca(OH)₂) to Make Quicklime (CaO))

In some embodiments, the heat released from an acid generating system may be used for the production of quicklime (CaO) via the calcination of calcium hydroxide (Ca(OH)₂) following Equation 17 provided below.

$${Ca ( OH )}_{2} \to CaO + {H}_{2} O , ΔH = 108.3 kJ / mol \qquad Eq . 17$$

In some embodiments, the reaction may take place at a temperature less than or equal to 300° C., 350° C., 400° C., 450° C., 500° C., 512° C., 550° C., 600° C., 650° C., 700° C., 750° C., or 800° C. In some embodiments, the reaction may take place at a temperature greater than or equal to 300° C., 350° C., 400° C., 450° C., 500° C., 512° C., 550° C., 600° C., 650° C., 700° C., 750° C., or 800° C. For example, the reaction temperature may be around 512° C. In some embodiments, a heat input may be used to heat the starting calcium hydroxide from a starting temperature of about 25° C. to a final temperature of 512° C., then drive the reaction of provided above in Equation 17 to create CaO. The specific heat capacity of calcium carbonate may be around 1.18 KJ/kg.° C. The sensible heat needed to increase the temperature of the calcium hydroxide from 25° C. to 512° C. may be around 576 kJ/kg Ca(OH)₂. The enthalpy of reaction may be about 1459 KJ/kg Ca(OH)₂. Thus, the thermodynamic minimum heat energy input requirement may be about 2035 KJ/kg Ca(OH)₂. Based on the reaction stoichiometry of Equation 17, the reaction of 1 mol Ca(OH)₂ may produce 1 mol CaO. Therefore, an input of 1 kg Ca(OH)₂ may produce an output of 0.76 kg CaO. In some embodiments, the total thermodynamic minimum heat energy input requirement may be about 2690 KJ/kg CaO.

As mentioned above, the heat output of an acid generating system described herein may be about 2490 KJ/kg dry calcium hydroxide. Therefore, the total heat output of the acid generating system may be sufficient to calcine the entire quantity of dry calcium hydroxide.

In some embodiments, it may not be possible to use all the heat released by the acid generating system, at least because the temperature may not be above 300° C., 350° C., 400° C., 450° C., 500° C., 512° C., 550° C., 600° C., 650° C., 700° C., 750° C., or 800° C. In some embodiments, it may not be possible to use all the heat released by the acid generating system due to heat loss to the environment and/or process inefficiency. In some embodiments, the heat output of the acid generating system may be enough to calcine less than or equal to 10%, 20%, 30%, 40%, 50%, 60%, 70%, 80%, 90%, or 100% of the calcium hydroxide produced using the system described above at least with respect to FIGS. 1A-1C and FIG. 2. In some embodiments, the heat output of the acid generating system may be enough to calcine greater than or equal to 10%, 20%, 30%, 40%, 50%, 60%, 70%, 80%, 90%, or 100% of the calcium hydroxide produced. In some embodiments, the heat output of the acid generating system may be enough to produce less than or equal to 0.05 kg, 0.10 kg, 0.15 kg, 0.20 kg, 0.25 kg, 0.30 kg, 0.35 kg, 0.40 kg, 0.45 kg, 0.50 kg, 0.55 kg, 0.60 kg, 0.65 kg, 0.70 kg, or 0.75 kg CaO per 1 kg dry calcium hydroxide. In some embodiments, the heat output of the acid generating system may be enough to produce greater than or equal to 0.05 kg, 0.10 kg, 0.15 kg, 0.20 kg, 0.25 kg, 0.30 kg, 0.35 kg, 0.40 kg, 0.45 kg, 0.50 kg, 0.55 kg, 0.60 kg, 0.65 kg, 0.70 kg, or 0.75 kg CaO per 1 kg dry calcium hydroxide.

In some embodiments, the calcium hydroxide may be calcined in a kiln and/or a flash calciner. The heat from the acid generating system may be conveyed to the equipment used for calcining the calcium hydroxide via conduction, convection, and/or radiation. In some embodiments, the heat may be carried in a process stream comprising primarily the high temperature acid (e.g., hydrochloric acid). In some embodiments, a heat exchanger may be used to transfer the heat from the acid to a heat transfer fluid such as water, a solvent, and/or a molten salt, and then this heat transfer fluid may heat the reactor used to calcine the calcium hydroxide.

### Example 7. Reaction of Lime (CaO or Ca(OH)₂) with Silica (SiO₂) to Form Alite (Ca₃SiO₅)

When lime (CaO and/or Ca(OH)₂) is combined with SiO₂ with the correct stoichiometry and heated, it may react to form alite (tricalcium silicate, Ca₃SiO₅), which is the main active phase in Portland cement clinker. In some embodiments, the heat from the acid generating system described herein may be used to react lime with silica to generate alite. In some embodiments, the starting materials may comprise calcium oxide, calcium hydroxide, calcium carbonate, and/or other sources of calcium. In some embodiments, the starting materials may comprise silica, aluminosilicates, clay, pozzolans, supplementary cementitious materials, coal ash, slag, natural pozzolans, olivines, and/or other sources of silica. In some embodiments, the starting materials may be ground, leached, calcined, or otherwise treated or processed before they are used for alite synthesis.

In some embodiments, the starting materials may comprise Ca(OH)₂ and silica. In some embodiments, the Ca(OH)₂ may first undergo the reaction shown in Equation 17 above to form CaO, then the resulting CaO may react with SiO₂ to form alite following Equation 18 provided below.

$$3 CaO + {SiO}_{2} \to {Ca}_{3} {SiO}_{5} , ΔH = - 113 kJ / mol \qquad Eq . 18$$

In some embodiments, the reaction of may take place at a temperature of less than or equal to 1200° C., 1250° C., 1300° C., 1350° C., 1400° C., 1420° C., 1450° C., 1500° C., 1550° C., or 1600° C. In some embodiments, the reaction of may take place at a temperature of greater than or equal to 1200° C., 1250° C., 1300° C., 1350° C., 1400° C., 1420° C., 1450° C., 1500° C., 1550° C., or 1600° C. For example, the reaction temperature may be about 1500° C. In some embodiments, a heat input may be used to heat the starting calcium oxide and silica from a starting temperature of about 25° C. to a final temperature of 1500° C., and to drive the reactions of Equations 17 and 18. Parameters for heat requirement calculations may be below in Table 5.

TABLE 5
Properties for alite production.

| Material Property | Value | Unit |
|---|---|---|
| Heat capacity, calcium hydroxide | 87.5 | J/mol K |
| Heat capacity, calcium oxide | 55 | J/mol K |
| Heat capacity, silicon dioxide | 67 | J/mol K |

The steps and heat inputs provided below in Table 6 may be applied to carry out the alite synthesis reaction from Ca(OH)₂ and SiO₂.

TABLE 6
Steps and heat inputs for alite synthesis.

| # | Step | Heat |
|---|---|---|
| (1) | Sensible heat to raise Ca(OH)₂ from 25° C. to | 42.6 kJ/mol |
| | 512° C. | Ca(OH)₂ |
| (2) | Heat of reaction to produce CaO via Eq. 15 | 108.3 kJ/mol |
| | | CaO |
| (3) | Sensible heat to raise CaO from 512° C. to 1500° C. | 54.3 kJ/mol |
| | | CaO |
| (4) | Sensible heat to raise SiO2 from 25° C. to 1500° C. | 98.8 kJ/mol |
| | | SiO₂ |
| (5) | Heat of reaction to produce Ca₃SiO₅ via Eq. 16 | −113 kJ/mol |
| | | Ca₃SiO₅ |
| Total | Total heat requirement: | 601 kJ/mol |
| | 3*(1) + 3*(2) + 3*(3) + (4) + (5) | Ca₃SiO₅ |

In some embodiments, the overall heat provided to perform this series of reactions, including the sensible heat to bring the reactants to temperature, may be 601 kJ/mol alite, which may be equivalent to 2638 KJ/kg of alite produced. In some embodiments, 184 kJ of heat may be released from the acid generating system described above per 1 mol Ca(OH)₂. Based on the reaction stoichiometry, 3 mol Ca(OH)₂ may be provided to produce 1 mol alite. In some embodiments, 552 kJ per 3 mol Ca(OH)₂ of heat may be produced, and 601 kJ/mol alite heat input may be provided for the sequence of reactions. Therefore, the heat may be sufficient to produce 0.918 mol alite per 3 mol Ca(OH)₂ produced. In some embodiments, based on the molar masses of alite and calcium hydroxide, the heat may be sufficient to produce 0.94 kg alite per 1 kg Ca(OH)₂.

In some embodiments, at least a portion of the generated heat can first be used to dry a wet calcium hydroxide filter cake. Following drying, the reaction pathway provided in Equations 17 and 18 may be followed. In this schema, the energy provided to convert three moles of Ca(OH)₂ slurry into one mole of alite may be 883 KJ/mol alite, meaning that in some embodiments, the heat from the acid generating system may be enough to convert 62.5% of the calcium hydroxide output into alite.

In some embodiments, the calcination reactor driving off water from calcium hydroxide to yield calcium oxide may be heated by a concentrated solar array yielding temperatures around 500° C. This operating temperature may be attainable using a central tower style concentrated solar array, allowing for the most energy-intensive steps of drying the lime slurry and reacting (e.g., Equation 3 provided above) to be carried out in a renewable manner. In some embodiments, the reactants of calcium oxide and silicon dioxide may already be heated to 500° C. by concentrated solar energy. In some embodiments, only about 653 KJ/kg of alite produced may require the high-temperature heat from the acid generating system.

In some embodiments, it may not be possible to use all the heat released by the acid generating system, at least because the temperature of the heat source and/or heat transfer fluid may not be above a threshold temperature. In some embodiments, it may not be possible to use all the heat released by the acid generating system due to heat loss to the environment and/or process inefficiency. In some embodiments, the heat output of the acid generating system may be enough to produce less than or equal to 0.1 kg, 0.2 kg, 0.3 kg, 0.4 kg, 0.5 kg, 0.6 kg, 0.7 kg, 0.8 kg, or 0.9 kg alite per 1 kg dry calcium hydroxide. In some embodiments, the heat output of the acid generating system may be enough to produce greater than or equal to 0.1 kg, 0.2 kg, 0.3 kg, 0.4 kg, 0.5 kg, 0.6 kg, 0.7 kg, 0.8 kg, or 0.9 kg alite per 1 kg dry calcium hydroxide.

### Example 8. Reaction of Limestone, Clay, and Sand to Form Portland Cement Clinker

In some embodiments, the heat produced by the acid generating system may be used to produce cement, such as ordinary Portland cement. The ordinary Portland cement may be produced by a thermal conversion of limestone and clay. In some embodiments, the ratio of limestone to clay may determine the amount of heat that may be used for the conversion. In some embodiments, the input materials may be heated to a temperature of less than or equal to 700° C., 750° C., 800° C., 850° C., 900° C., 950° C., 1000° C., 1050° C., 1100° C., 1150° C., 1200° C., 1250° C., 1300° C., 1350° C., 1400° C., 1420° C., 1450° C., 1500° C., 1550° C., 1600° C., 1650° C., or 1700° C. In some embodiments, the input materials may be heated to a temperature of greater than or equal to 700° C., 750° C., 800° C., 850° C., 900° C., 950° C., 1000° C., 1050° C., 1100° C., 1150° C., 1200° C., 1250° C., 1300° C., 1350° C., 1400° C., 1420° C., 1450° C., 1500° C., 1550° C., 1600° C., 1650° C., or 1700° C. For example, the thermal conversion temperature may be about 1500° C. In some embodiments, the heat provided for ordinary Portland cement clinker production, including sensible heat, may be 3850 KJ/kg cement clinker. In some embodiments, 0.65 kg of Portland cement clinker may be produced with the heat from the acid generating system described herein per 1 kg of dry Ca(OH)₂.

### Example 9. Calcination of Natural Clay to Make Calcined Clay

In some embodiments, the heat from the acid generating system may be used to calcine clay for the creation of high-performance pozzolans. In some embodiments, this may require heating a clay to less than or equal to 500° C., 550° C., 600° C., 650° C., 700° C., 750° C., 800° C., 850° C., or 900° C. to drive the water out of the clay interlayers. In some embodiments, calcining clay may require heating a clay to greater than or equal to 500° C., 550° C., 600° C., 650° C., 700° C., 750° C., 800° C., 850° C., or 900° C. For example, the calcination temperature may be about 750° C. While there are many types of clays with large deposits, the most relevant mineral of clay for cementitious systems may comprise of kaolinite. Kaolinite may have a layered octahedrally coordinated alumina layer bonded via oxygen to a tetrahedrally coordinated silica layer. The layered structure of kaolinite may bond together with water, providing hydrogen bonds between the sheets. The overall formula for kaolinite is Al₂O₃-2SiO₂-2H₂O. Because of the regular long-range order, kaolinite may be highly crystalline. This material may be unreactive in cementitious systems and may require thermal treatment to drive the hydroxyl groups out of the structure. It is hypothesized that this dehydroxylization activates the structure for use in cement systems. The dehydroxylated structure may be referred to as metakaolin and has a formula of Al₂O₃-2SiO₂. Because the water is chemically bound to kaolinite, it may not be driven off at water's boiling point of 100° C. Instead, it is a highly endothermic reaction, which may occur at less than or equal to 500° C., 550° C., 600° C., 650° C., 700° C., 750° C., 800° C., 850° C., or 900° C. In some embodiments, the reaction may occur at greater than or equal to 500° C., 550° C., 600° C., 650° C., 700° C., 750° C., 800° C., 850° C., or 900° C. The reaction pathway may occur as shown below in Equation 19.

$${Al}_{2} {O}_{3} - 2 {SiO}_{2} - 2 {H}_{2} O \to {Al}_{2} {O}_{3} - 2 {SiO}_{2} + 2 {H}_{2} O , ΔH = 550 kJ / kg \qquad Eq . 19$$

In some embodiments, the clay may be calcined at a temperature of less than or equal to 500° C., 550° C., 600° C., 650° C., 700° C., 750° C., 800° C., 850° C., or 900° C. In some embodiments, the clay may be calcined at a temperature of greater than or equal to 500° C., 550° C., 600° C., 650° C., 700° C., 750° C., 800° C., 850° C., or 900° C. Using the specific heat of kaolinite of 1.1 J/g*K and the enthalpy of the dehydroxylation, the total heat used to calcine kaolin may be determined. To produce 1 kg of metakaolin, 1566 kJ of heat input may be provided. As mentioned above, the heat output of an acid generating system may be 2490 KJ/kg dry calcium hydroxide. Therefore, the heat output from an acid generating system from 1 kg of dry calcium hydroxide may provide sufficient heat to produce about 1.59 kg of metakaolin from about 1.85 kg kaolinite.

In some embodiments, an impure clay source may be used. For example, the clay may comprise some content of kaolin along with other impurities such as iron oxide, silica quartz, and/or other species of interlayered clays. These impurities may affect the calcination dynamics. For example, the impurity species may be crystalline silica, which may be inert up to 900° C. Thus, the enthalpy for calcining one kilogram of clay feedstock may be reduced. In some embodiments, the heat provided for producing 1 kg of calcined clay may be reduced to less than or equal to 500 kJ, 600 kJ, 700 kJ, 800 kJ, 900 kJ, 1000 kJ, 1100 kJ, 1200 kJ, 1300 kJ, 1400 KJ or 1500 kJ. In some embodiments, the heat may be reduced to greater than or equal to 500 kJ, 600 kJ, 700 kJ, 800 kJ, 900 kJ, 1000 kJ, 1100 kJ, 1200 kJ, 1300 kJ, 1400 KJ or 1500 kJ. As mentioned above, the heat output of an acid generating system described herein may be 2490 KJ/kg dry calcium hydroxide. Thus, the heat output from an acid generating system may provide sufficient heat to produce less than or equal to 1.6 kg, 1.7 kg, 1.8 kg, 1.9 kg, 2.0 kg, 2.5 kg, 3.0 kg, 3.5 kg, 4.0 kg, 4.5 kg, or 5 kg of calcined clay. In some embodiments, the heat output from an acid generating system may provide sufficient heat to produce greater than or equal to 1.6 kg, 1.7 kg, 1.8 kg, 1.9 kg, 2.0 kg, 2.5 kg, 3.0 kg, 3.5 kg, 4.0 kg, 4.5 kg, or 5 kg of calcined clay.

In some embodiments, it may not be possible to use all the heat released by the acid generating system, at least because the temperature may not be above 700° C., 750° C., 800° C., 850° C., 900° C., 950° C., 1000° C., 1050° C., 1100° C., 1150° C., or 1200° C. In some embodiments, it may not be possible to use all the heat released by the acid generating system due to heat loss to the environment and/or process inefficiency. In some embodiments, the heat output of the acid generating system may be enough to calcine less than or equal to 0.1 kg, 0.2 kg, 0.3 kg, 0.4 kg, 0.5 kg, 0.6 kg, 0.7 kg, 0.8 kg, 0.9 kg, 1.0 kg, 1.1 kg, 1.2 kg, 1.3 kg, 1.4 kg, 1.5 kg, 1.6 kg, 1.7 kg, or 1.8 kg of kaolinite per 1 kg dry calcium hydroxide. In some embodiments, the heat output of the acid generating system may be enough to calcine greater than or equal to 0.1 kg, 0.2 kg, 0.3 kg, 0.4 kg, 0.5 kg, 0.6 kg, 0.7 kg, 0.8 kg, 0.9 kg, 1.0 kg, 1.1 kg, 1.2 kg, 1.3 kg, 1.4 kg, 1.5 kg, 1.6 kg, 1.7 kg, or 1.8 kg of kaolinite per 1 kg dry calcium hydroxide. In some embodiments, the heat output of the acid generating system may be enough to produce less than or equal to 0.1 kg, 0.2 kg, 0.3 kg, 0.4 kg, 0.5 kg, 0.6 kg, 0.7 kg, 0.8 kg, 0.9 kg, 1.0 kg, 1.1 kg, 1.2 kg, 1.3 kg, 1.4 kg, or 1.5 kg metakaolin per 1 kg dry calcium hydroxide. In some embodiments, the heat output of the acid generating system may be enough to produce greater than or equal to 0.1 kg, 0.2 kg, 0.3 kg, 0.4 kg, 0.5 kg, 0.6 kg, 0.7 kg, 0.8 kg, 0.9 kg, 1.0 kg, 1.1 kg, 1.2 kg, 1.3 kg, 1.4 kg, or 1.5 kg metakaolin per 1 kg dry calcium hydroxide.

### Example 10. Production of Sodium Silicate

In some embodiments, the heat from the acid generating system may be used for the production of sodium silicate, which may have the chemical formula of (Na₂O)ₓ·(SiO₂) y. Typical sodium silicates include but are not limited to sodium metasilicate (Na₂SiO₃), sodium orthosilicate (Na₄SiO₄), and sodium pyrosilicate (Na₆Si₂O₇). In some embodiments, the input materials may comprise silica sand (SiO₂) and soda ash (Na₂CO₃). In some embodiments, the input materials may be heated to a temperature of less than or equal to 700° C., 750° C., 800° C., 850° C., 900° C., 950° C., 1000° C., 1050° C., 1100° C., 1150° C., 1200° C., 1250° C., 1300° C., 1350° C., 1400° C., 1420° C., 1450° C., 1500° C., 1550° C., or 1600° C. In some embodiments, the input materials may be heated to a temperature of greater than or equal to 700° C., 750° C., 800° C., 850° C., 900° C., 950° C., 1000° C., 1050° C., 1100° C., 1150° C., 1200° C., 1250° C., 1300° C., 1350° C., 1400° C., 1420° C., 1450° C., 1500° C., 1550° C., or 1600° C. For example, the reaction temperature may be about 1100° C. In some embodiments, sodium silicate may be used as an activator, set accelerator, strength accelerator, and/or strength increasing admixture for cement and/or concrete.

### Example 11. Production of Calcium Sulfoaluminate Cement

In some embodiments, the heat from an acid generating system may be used for the production of calcium sulfoaluminate cements. Calcium sulfoaluminate cements may be produced via the calcination of input materials comprising bauxite and limestone. In some embodiments, the input materials for calcium sulfoaluminate cement manufacturing may comprise alternative sources of sulfur, calcium, and/or aluminum such as slags, ashes, or kiln dusts. In some embodiments, the input materials may be heated to a temperature of less than or equal to 700° C., 750° C., 800° C., 850° C., 900° C., 950° C., 1000° C., 1050° C., 1100° C., 1150° C., 1200° C., 1250° C., 1300° C., 1350° C., 1400° C., 1420° C., 1450° C., 1500° C., 1550° C., or 1600° C. In some embodiments, the input materials may be heated to a temperature of greater than or equal to 700° C., 750° C., 800° C., 850° C., 900° C., 950° C., 1000° C., 1050° C., 1100° C., 1150° C., 1200° C., 1250° C., 1300° C., 1350° C., 1400° C., 1420° C., 1450° C., 1500° C., 1550° C., or 1600° C. For example, the calcination temperature may be about 1300° C. In some embodiments, this high temperature process may produce a material comprising the mineral Ye'elimite, which may have the chemical notation of Ca₄(AlO₂)₆SO₄.

The above-described example uses of heat are not intended to be limiting. For example, the heat produced from acid generation may be used for chemical process steps such as oxidation, reduction, hydrogenation, dehydrogenation, hydrolysis, hydration, dehydration, halogenation, nitrification, sulfonation, amination, alkylation, dealkylation, esterification, polymerization, polycondensation, catalysis, evaporation, distillation, drying, sintering, calcining, annealing, crystallization, fractionation, cracking, reforming, and/or purification, as will be apparent to one or ordinary skill in the art.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. Such modifications and variations are to be understood as being included within the scope of the disclosure and examples as defined by the claims. The embodiments were chosen and described in order to best explain the principles of the techniques and their practical applications. Others skilled in the art are thereby enabled to best utilize the techniques and various embodiments with various modifications as are suited to the particular use contemplated. For the purpose of clarity and a concise description, features are described herein as part of the same or separate embodiments; however, it will be appreciated that the scope of the disclosure includes embodiments having combinations of all or some of the features described.

### Additional Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Reference to “about” a value or parameter herein includes (and describes) variations that are directed to that value or parameter per se. For example, description referring to “about X” includes description of “X”. In addition, reference to phrases “less than”, “greater than”, “at most”, “at least”, “less than or equal to”, “greater than or equal to”, or other similar phrases followed by a string of values or parameters is meant to apply the phrase to each value or parameter in the string of values or parameters. For example, a statement that a layer has a thickness of at least about 5 cm, about 10 cm, or about 15 cm is meant to mean that the layer has a thickness of at least about 5 cm, at least about 10 cm, or at least about 15 cm.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

1. A system for using heat from acid generation comprising:
an acid generating system configured to generate heat and an acid;
a wet solids generating system configured to:
dissolve a first calcium source in the acid; and
precipitate a second calcium source using the dissolved first calcium source to generate a wet solid; and
a dryer configured to dry the wet solid using the heat from the acid generating system.

2. The system of claim 1, wherein the acid generating system comprises a heat exchanger configured to transfer the heat from the acid generating system to a heat transfer fluid.

3. The system of claim 2, wherein the dryer is configured to dry the wet solid using heat from the heat transfer fluid.

4. The system of any one of claims 2-3, further comprising a second heat exchanger configured to transfer heat from the first heat transfer fluid to a second heat transfer fluid.

5. The system of claim 4, wherein the dryer is configured to dry the wet solid using heat from the second heat transfer fluid.

6. The system of claim 5, further comprising:
a sensor configured to measure a property of the dried wet solid; and
a controller configured to adjust the flow of the second heat transfer fluid to the dryer based on a determination that the measured property of the dried wet solid is outside of a threshold range.

7. The system of claim 6, wherein the sensor is a moisture sensor, and the property is moisture content.

8. The system of claim 7, wherein the threshold range is a moisture content of 0.1-10 wt. %.

9. The system of any one of claims 4-8, further comprising:
a sensor configured to measure a property of the second heat transfer fluid after the second heat exchanger; and
a controller configured to adjust the flow of the first heat transfer fluid to the second heat exchanger based on a determination that the measured property of the second heat transfer fluid is outside of a threshold range.

10. The system of claim 9, wherein the sensor is a temperature sensor, and the property is temperature.

11. The system of any one of claims 2-10, further comprising:
a sensor configured to measure a property of the dried wet solid source; and
a controller configured to adjust the flow of the heat transfer fluid based on a determination that the measured property of the dried wet solid is outside of a threshold range.

12. The system of any one of claims 1-11, wherein the acid generating system is configured to generate heat and an acid using a hydrogen gas and a halide gas.

13. The system of claim 12, wherein the acid generating system comprises a burner configured to generate a hydrogen halide gas using the hydrogen gas and the halide gas; and an absorber configured to absorb the hydrogen halide gas in a solvent to form the acid.

14. The system of claim 13, wherein the halide gas comprises a dihalide gas.

15. The system of claim 14, wherein the dihalide gas comprises F₂, Cl₂, or Br₂.

16. The system of claim 15, wherein the hydrogen halide gas comprises hydrogen chloride.

17. The system of any one of claims 1-16, wherein the wet solid generating system comprises a dissolution chamber configured to dissolve the first calcium source in the acid; and a precipitation chamber configured to precipitate the second calcium source using the dissolved first calcium source.

18. The system of any one of claims 1-17, wherein the first calcium source comprises calcium carbonate, lime, lime dust, lime kiln dust, cement kiln dust, slag from metal production, igneous or metamorphic rock, and/or furnace ash.

19. The system of any one of claims 1-18, wherein the second calcium source comprises calcium hydroxide.

20. The system of any one of claims 1-19, wherein the first calcium source comprises a pozzolan source.

21. The system of claim 20, wherein dissolving the first calcium source comprising the pozzolan source comprises generating a second wet solid comprising the pozzolan source.

22. The system of claim 21, wherein the dryer is configured to dry the second wet solid comprising the pozzolan source.

23. A method for using heat in acid generation comprising:
generating heat and an acid;
dissolving a first calcium source in the acid;
precipitating a second calcium source using the dissolved first calcium source to generate a wet solid; and
drying the wet solid using the heat from the acid generation.

24. The method of claim 23, comprising transferring the heat generated to a heat transfer fluid and drying the wet solid using the heat transfer fluid.

25. The method of any one of claims 23-24, comprising transferring heat from the heat transfer fluid to a second heat transfer fluid and drying the wet solid using the second heat transfer fluid.

26. A method for using heat in acid generation comprising:
generating heat and an acid;
dissolving a first calcium source in the acid;
precipitating a second calcium source using the dissolved first calcium source; and
performing an operation using the heat from acid generation.

27. The method of claim 26, wherein the operation comprises evaporating a solvent.

28. The method of claim 27, wherein the operation comprises drying a wet solid or drying an input source such as coal ash or mining tailings.
